(19) United States
(12) Patent Application Publication
(10) Pub. No.: US 2025/0348146 A1
(43) Pub. Date: Nov. 13, 2025

(54) INTEGRATED SMART SYSTEM CONTROLLABLE BY ASYNCHRONOUS EEG BASED BRAINCOMPUTER INTERFACE USING RIEMANNIAN GEOMETRY USING EMBEDDED ROBOTOPERATING SYSTEM

(71) Applicant: Board of Regents, The University of Texas System, Austin, TX (US)

(72) Inventor: Prasanna Kolar, San Antonio, TX (US)

(21) Appl. No.: 19/205,984

(22) Filed: May 12, 2025

Related U.S. Application Data
(60) Provisional application No. 63/645,935, filed on May 12, 2024.

(51) Int. Cl. G06F 3/01; A61G 5/00

(52) U.S. Cl. CPC G06F 3/015; A61G 5/003; A61G 2203/12; A61G 2203/18; A61G 2203/22

(57) ABSTRACT

The invention discloses an integrated non-intrusive, safe and user-friendly electroencephalography (EEG) system capable of classifying signals generated from both Event Related Potential (ERP) based steady-state visually evoked potential (SSVEP) and pure cognition, leveraging Riemannian Geometry-based signal classification algorithms for precise command generation. The system seamlessly combines SSVEP-based visual stimuli with cognition-based EEG signals to provide a comprehensive interface for brain-computer interaction (BCI) applications. Riemannian Geometry techniques are employed for robust signal classification and efficient command generation, enhancing the system's accuracy and reliability.

### RELATED APPLICATIONS

This application claims priority to U.S. Provisional Patent Application 63/645,935 filed May 12, 2024 which is incorporated herein by reference in its entirety.

### STATEMENT REGARDING FEDERALLY FUNDED RESEARCH

None.

### FIELD

Embodiments are generally directed to the field of medicine and rehabilitative medicine. Embodiments are directed more particularly to the field of assisted mobility.

### BACKGROUND

Over the past few centuries, people with limb disabilities or weakness have been dependent on wheeled assistive mobility systems to move around. For example, the first documented wheelchair (self-propelled) was invented in 1655 by the paraplegic clock maker Stephan Farfler (1633-1689) from Nuremberg, Germany [Kay Nias (2019)] built his own mobility aid when he was just 22 of age. Until the 1950s, manual wheelchairs have been used by the affected person(s) themselves, or by their assistants to move about. Over the past 5 decades, physically challenged individuals who are too weak or unable to manually-propel themselves in manual/push-powered wheelchairs, have used electric/motor-powered wheelchairs. These types of wheelchairs greatly improve the potential of such people for self-fulfillment. Disability of the human motor system affects about 42 million of the approximately 345 million residents of the USA [UCED et al. (2018)]. This is about 13% of the population. Of this, about 30 to 40% suffer serious disabilities involving their motor skills. The causes of such disabilities could be due to trauma or disease. The traumatic injuries cause spinal cord injury or damage to the limbs. The diseases are Lou Gehrig's Disease (ALS), Spina Bifida, Parkinsons, cerebral palsy, muscular dystrophy, multiple sclerosis (MS), arthritis, tremors.

Persons suffering from such disabilities, disorders or diseases are unable to use their motor skills or other essential abilities. This has and will continue to have an impact on their livelihood or even their survival in many cases or be able to assist them in coping with their disabilities since a cure may not be possible in many cases.

### SUMMARY

A solution to the problems and issues presented above is the development of an integrated smart system controllable by asynchronous EEG based Brain Computer Interface using Riemannian Geometry using embedded robot operating system.

Embodiments provide a novel framework that integrates a smart assisted living and smart mobility system with a Riemannian Geometry based brain computing interface (BCI). The BCI which is a cognitive-control model uses the Riemannian Geometry to accurately and quickly classify the brain signals to command the smart mobility system as desired by the operator. The BCI is implemented on an embedded GPU enabled wireless hardware system that contains a programmable control model. The framework comprises (1) An EEG Signal classification model that uses concepts of Riemannian Geometry to output a command to control, for example, an intelligent Wheelchair; (2) A novel Control architecture model to control an autonomous rehabilitation mobility system which is connected over an intranet using commands generated by the human brain; (3) A novel integration technology that integrates the BCI with the smart mobility on a low power embedded control system.

Embodiments are directed to a brain computer interface (BCI) configured to translate event related potentials (ERP) in electroencephalograph (EEG) wave forms into commands executable by an assistance device(s) or system(s) comprising a user interface coupled to an electroencephalograph (EEG) decoder that is configured to receive and analyze EPR in EEG wave forms and producing a command signal. In certain aspects the EPR is a visually evoked ERP in combination with a cognitive ERP. In certain aspects the ERP comprises a steady state visually evoked potential (SSVEP) using Riemannian manifold classifiers.

Certain embodiments are directed to an electroencephalograph (EEG) decoder comprising (i) an input module coupled to (ii) a fast Fourier transform (FFT) module which is operably coupled to (iii) a wave band analysis module that generates a command to be sent to one or more device or system. The wave band analysis can use Riemannian geometry based signal classification system to generate commands that are sent to one or more devices or systems.

Certain embodiments are directed to a mobility system comprising: a brain computer interface (BCI) configured to receive electroencephalograph (EEG) waveforms, analyze event related potentials (ERP) EEG wave forms in a plurality of predetermined frequency ranges or band types forming a signal, and generate a command based on the signal generated by ERP analysis; one or more environmental sensors configured to receive active and passive information regarding an environment; a mobility platform configured to receive input from the brain computer interface and the one or more environmental sensors to regulate the function of the mobility platform.

Certain embodiments are directed to methods for EEG signal classification and command generation comprising: a. capturing EEG signals generated from both SSVEP and pure cognition activities; b. preprocessing the captured EEG signals for removal of noise and artifacts; c. extracting relevant features from the preprocessed EEG signals using Riemannian Geometry-based techniques; d. classifying the extracted features into distinct cognitive states or commands using Riemannian Geometry-based classification algorithms; and generating commands or actions based on the classified cognitive states for controlling external devices and systems/applications. In certain aspects the SSVEP signals are elicited through re-configurable visual stimuli presented at specific frequencies, and the pure cognition signals are generated through thoughts without external stimuli, representing cognitive tasks or intentions. In certain aspects the ERP signals are elicited with minimal user training for signal generation, enabling command generation in seconds. The preprocessing step can include filtering, artifact removal, and feature extraction to enhance the quality and discriminability of EEG signals. The Riemannian Geometry-based techniques can involve modeling EEG signals as points on Riemannian manifold(s), enabling efficient representation and classification of high-dimensional EEG data. The classification algorithms employ Riemannian distance metrics or manifold-based classifiers to accurately classify EEG signals into predefined cognitive states and finally into commands that are executed on smart systems like autonomous wheelchairs, smart home systems and similar systems.

Other embodiments are directed to an EEG system for SSVEP and pure cognition signal classification and command generation comprising: a. EEG signal acquisition hardware capable of capturing signals from multiple comfortable electrodes embedded into everyday objects like caps, hats and helmets; b. signal preprocessing modules for noise reduction, artifact removal, banding, and feature extraction; c. Riemannian geometry-based signal classification algorithms for the cognitive state and command classification; d. command generation modules for translating classified cognitive states into control commands for smart devices and systems. The EEG system can include a hierarchical user interface for real-time user-feedback and interaction, allowing users to monitor their cognitive states and control the system's output. The EEG system can include a real time emergency stoppage system to eliminate any untoward incidents, experienced while using the system. The signal acquisition hardware can include soft electrodes or non-invasive electrode arrays for comfortable, accurate and convenient EEG signal acquisition. The Riemannian Geometry-based signal classification algorithms can be implemented using machine learning techniques. The command generation modules can support various applications including neurofeedback, assistive technologies, command accepting systems and smart home systems.

Novel aspects of the developed EEG system include but is not limited to integration of non-intrusive signal acquisition using SSVEP and pure cognition or thought signals, utilization of Riemannian Geometry-based techniques, and application in signal classification and command generation for diverse BCI applications.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a chemical composition and/or method that “comprises” a list of elements (e.g., components or features or steps) is not necessarily limited to only those elements (or components or features or steps), but may include other elements (or components or features or steps) not expressly listed or inherent to the chemical composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a chemical composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1. Illustration of intelligent wheelchair and power block.

FIG. 2. Illustration of one example of EEG processing.

FIG. 3. Diagram of wheelchair system.

FIG. 4. Block diagram of one example of a mobility system.

FIG. 5. Diagram of a 10-20 EEG system.

FIG. 6. Flow diagram of one example of a wheelchair system.

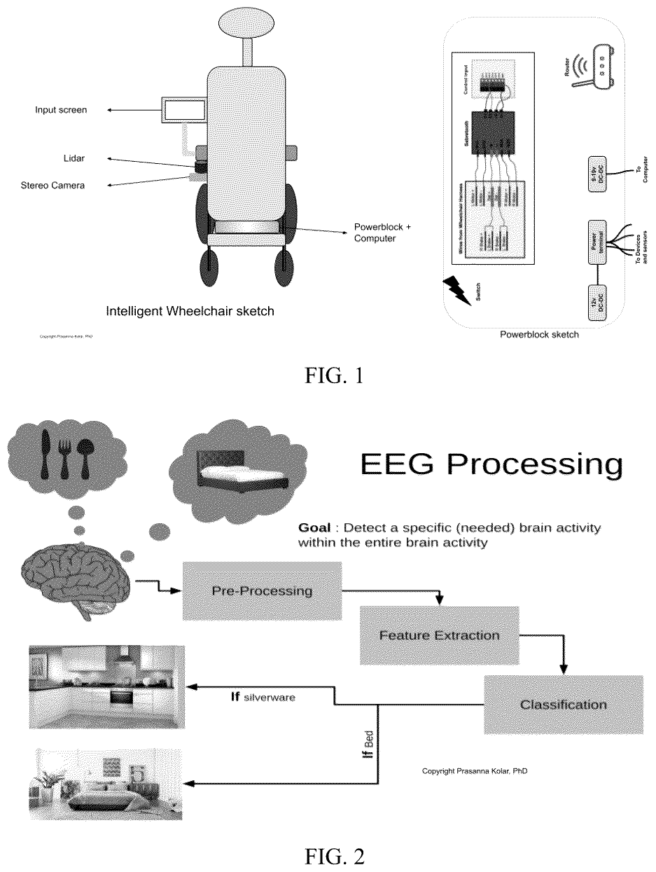

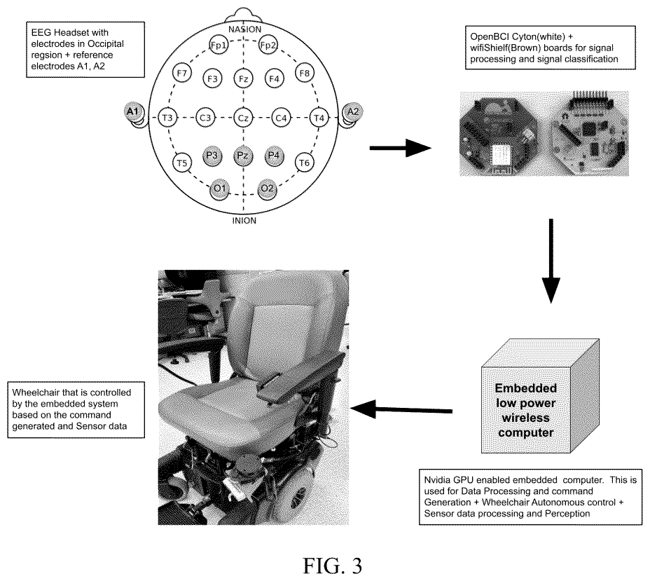

### DESCRIPTION

The following discussion is directed to various embodiments of the invention. The term “invention” is not intended to refer to any particular embodiments or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to imply that the scope of the disclosure, including the claims, is limited to that embodiment.

An EEG signal classification model based on Riemannian Geometry can be used to control and operate smart devices, such as wheelchairs in constricted environments. One of the motivations for this research is to improve the mobility capabilities of people with severe motor disabilities, for example a patient with MS. Such patients struggle with loss of independence in their life. Embodiments are directed at reducing their reliance on another person for their mobility needs or ameliorate their locked-in situation. The focus is on enabling such people to command a smart device or system, such as a wheelchair, by thought.

Motivations include 1. Aid in achieving Independence: Mobility is one of most important factors in being independent. This applied for most people. People with situations like ALS and other similar conditions. 2. Improve personal comfort. 3. Improve safety. There is an acute need for the community to overcome the mobility challenges of the disabled.

Persons with severe motor disabilities suffer from emotional and psychological trauma, in addition to the physical limitations due to their disability. Many people without their full motor capabilities still have a fully functioning brain and are capable of thinking, comprehension and other brain related functions. Several suffer from acute depression due to their physical disability and the fact that they are totally dependent on another person for their mobility requirements. They suffer from ‘Locked-in’ syndrome, which takes a heavy toll on their emotional and psychological well-being. This research is to develop a technology so that such people do not need to depend on another person for mobility and do not need to depend on their limbs or motor skills for their mobility requirements. Society needs to take responsibility to alleviate the challenges of such a community and hence the need for this research.

Conventional methods to control the electric wheelchairs include (a) Joystick, (b) Touchpad, and/or (c) Chin controller. Methods to control the wheelchairs also include (a) Tongue controller, (b) Eye graze tracking controller, and/or (c) Air sip-n-puff mouth controller. Smart Assistive Technologies include (a) RC Controlled Wheelchairs, (b) Human in Loop Semi-Autonomous Wheelchairs, (c) Fully Autonomous Wheelchairs commanded by voice, or (d) Fully Autonomous Wheelchairs commanded by cognition.

Persons with paraplegia and quadriplegia suffer not only physically but also mentally due to the locked-in syndrome that they experience due to heavy dependency on others for the simplest of mobility requirements. A novel integrated system comprising a powered smart wheelchair system, embedded cognition input system, and scalable asynchronous electroencephalogram (EEG)-based brain computing interface and a robot operation control system integrated on a low power embedded GPU computation has been developed to provide mobility to such persons with acute mobility-based disabilities.

The framework integrates a smart assisted living and smart mobility system with a Riemannian Geometry based brain computing interface (BCI), has been developed and is described herein. The BCI which is a cognitive-control model uses the Riemannian Geometry to accurately and quickly classify the brain signals to command the smart mobility system as desired by the operator. The BCI is implemented on an embedded GPU enabled wireless hardware system that contains a programmable control model. The framework comprises the following: (1) An EEG Signal classification model that uses concepts of Riemannian Geometry to output a command to control an intelligent Wheelchair. (2) A novel Control architecture model to control an autonomous rehabilitation mobility system which is connected over an intranet using commands generated by the human brain. (3) A novel integration technology that integrates the BCI with smart mobility on a low power embedded control system.

Riemannian manifolds are nonlinear and this property enables effective description of dynamic processes of activities involving non-planar movement, which lie on a nonlinear manifold other than a vector space. Low dimensional data points on the manifolds provide highly efficient in providing the video features, which maintaining the crucial properties like geometry and topology. The Riemannian geometry provides a way to measure the distances/dissimilarities between different objects on the nonlinear manifold, hence it is a suitable tool for classification and tracking. The proposed model is also compared with two of the most relevant manifold tracking methods. Results have shown much improved tracking performance in terms of tracking drift and tightness and accuracy of tracked objects.

A smart wheelchair that is controlled by human cognition using Riemannian Classification embedded computational technology and sensor integration has been developed for persons with acute mobility issues.

An embedded GPU based low power computational system has been integrated with an Electroencephalogram (EEG) based Brain Computer Interface (BCI) and a smart rehabilitation wheelchair system. This will be useful for brain controlled autonomous navigation, which provides mobility freedom to people experiencing “Locked-in” syndrome. This has been experienced by many people who have an active brain function, but are paralyzed neck down. They are dependent on others for the simplest of jobs like mobility from one part of the house to another. The mobility system comprises the powered wheelchair, the BCI contains the headset or similar device and the signal input system and a Riemannian Geometry based cognition classifier and the navigation system coupled to an embedded computational unit that contains the navigational and sensing modules. These systems together will assist the above mentioned groups of people, or anyone who needs assisted mobility and assistance, especially in simple navigation indoors in known environments is designed and developed.

High Level Architecture. A novel framework that integrates a smart assisted living and smart mobility system with a Riemannian Geometry based brain computing interface (BCI), has been developed. The BCI which is a cognitive-control model uses the Riemannian Geometry to accurately and quickly classify the brain signals to command the smart mobility system indoors as desired by the operator. The BCI is implemented on an embedded GPU enabled wireless hardware system that houses a programmable control model. The framework includes, but is not limited to (1) An EEG Signal classification model that uses concepts of Riemannian Geometry to output a command to control an intelligent Wheelchair; (2) A novel Control architecture model to control an autonomous rehabilitation mobility system which is connected over an intranet using commands generated by the human brain; (3) A novel integration technology that integrates the BCI with the smart mobility on a low power embedded control system.

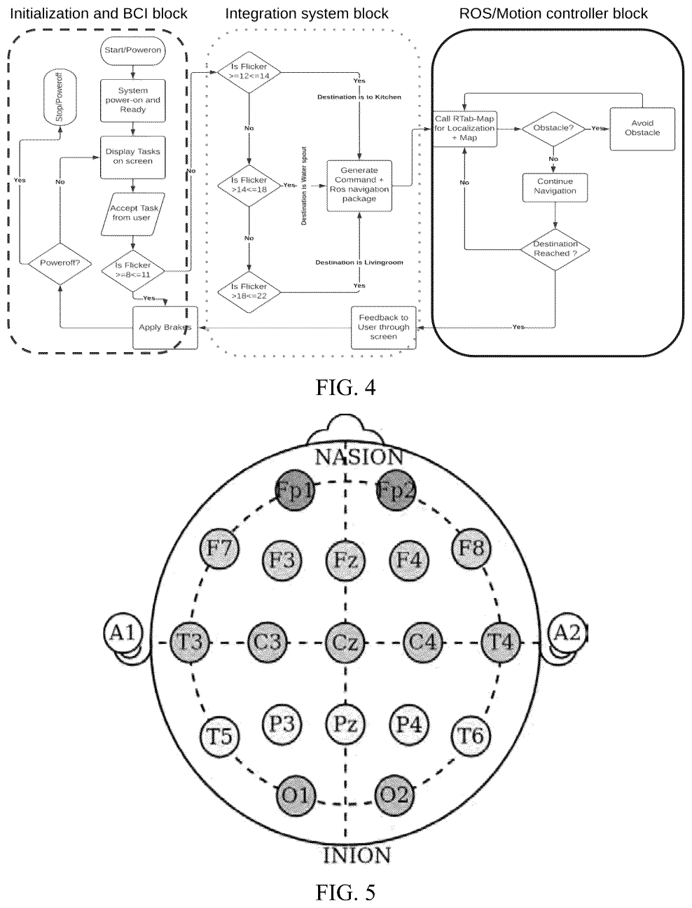

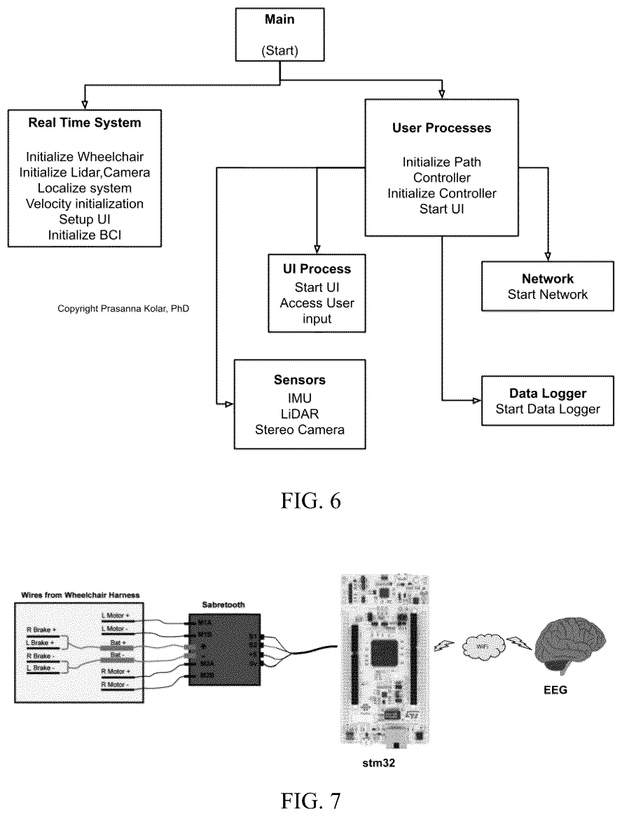

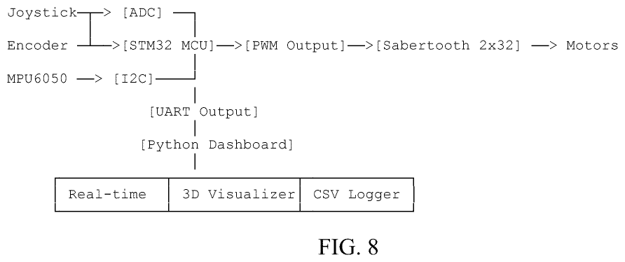

High Level Flow Diagram. Referring to FIG. 4, when the wheelchair is powered on based on the scheduled or manual start, the navigation and BCI systems are started and initialized and in a matter of seconds, the User Interface starts and is visible on the screen. The system is capable of schedule based self-powering, i.e., at a programmed time during the day, or power off which are re-configurable. This enables the system to be ready for user operations. The operator/user can generate a command by focusing on an image presented on the user interface (UI). Currently, the system can control a rehabilitation smart wheelchair. This system is scalable and re-programmable, i.e., additional smart systems can be added and parameters updated for the wheelchair unit. The mobility system comprises an intelligent/smart wheelchair that can be controlled by human cognition.

The mobility system has a mapping and localization software that provides maps of the area of mobility. If the maps are not available a priori (before the navigation), the unit is capable of generating the maps and localizing itself real time, while simultaneously performing the navigation to the destination of user's choice.

### I. Brain Computer Interface (BCI)

Brain computing Interface (BCI) is a system that enables Human-machine interactions without the need for conventional controls like a joystick, keyboard, mouse, motor capabilities, tongue, mouthpiece etc. A BCI broadly has 2 components (i) the human user and (ii) the computing system who interact mutually using a decoder, which translates the brain signals into executable commands and an interface that performs actions while informing the user about its operation. An Electroencephalography (EEG) based system is one that is capable of translating EEG signals into commands for an intelligent (computerized) system. EEG is of particular interest in this research, since it is non-invasive, safe and can be adopted on almost all systems. The study of brain activity through functional medical imaging devices is named neuroimaging. In the year 1929 Hans Berger [Hans Berger] provided the first EEG of a human being. This finding is often evoked as a starting point. To record EEG, a set of electrodes are applied on the scalp so to establish electrical contact with the skin and in such a way to sample as evenly as possible the available scalp surface. To obtain congruence among different laboratories and different head shapes and sizes, standard placements have been soon proposed, basing the positioning on proportional distances along head anatomical landmarks. In most of the everyday research, is carried out with 19 to 64 electrodes, although the number of electrodes used in research has increased over the decades from around 19 of Jasper's [Jasper, Herbert] time to as many as 512 today. The 10-20 electrode system with 19 electrodes is still the dominant standard. EEG Research areas have increased over the past 2 decades in the BCI. BCIs have immense use in the disabled community, since they can potentially assist the severely disabled by using their intentions to command wheelchair, smart devices like TV, media centers, smart homes etc. [Allison et al. (2012); Schomer and Da Silva (2012); Kubler et al. (2001) Kubler; Kotchoubey, Kaiser, Wolpaw, and Birbaumer, Zander et al. (2010), Wolpaw and Wolpaw (2012)]. The BCI can be broadly divided into 2 categories: (1) Signal Processing based: A signal pre-processing increases signal-noise ratio and is followed by a rudimentary classification technique. In this process there tends to be issues due to generalization and to compensate for the effects of these bad generalization, they have fast processing and have lower computational costs. There have been some updates to a second version of the signal processing. (2) Complete Machine Learning(ML) based: Conventional ML techniques are used to train the system and run. This technique needs a lot of training data and a lengthy, computationally intensive training process.

In certain aspects of the systems and methods described herein, pre-processing of the signal can be performed; followed by a module to increase the signal to noise ratio and finally classification of the signal to achieve command generation.

Smart devices can be utilized to assist people with severe mobility diseases. This can be achieved by integrating Brain Computer Interface (BCI) systems with the smart devices. BCI data is recorded in experiments that are repeated across sessions or test subjects. Any BCI modality for each subject is split into time windows which are termed as sessions or trials, which comprise of EEG data. This is defined as Xz where z∈{1, . . . , Z}which is the index of Z classes. Trials Xz are N×T EEG data matrices where N is the number of electrodes and the T the number of samples. The functioning of MDM is the same across several modalities, like SSVEP, P300 and so on. The difference is in how the covariance matrices are defined. The key factor is how efficiently we can capture all the required and pertinent information related to the experiment in a symmetric and positive matrix form. We refer to Congedo et. al. [Congedo and Barachant (2013), Congedo and Barachant (2017), Congedo and Rodriduez (2019)]

$${C}_{z} = \frac{1}{( T - 1 )} ( {X}_{z} {X}_{z}^{T} ) \qquad ( 1.1 )$$

Where Cz is the covariance matrix of the trial Xz. This covariance matrix contains every spatial information especially the second order details for the trial. The diagonal elements hold the variance of the involved signal at each of the electrodes while the off diagonal elements hold the covariance between every electrode pair.

Several researchers have continually studied the area of Riemannian Geometry for BCI M Congedo, A Barachant et. al. [Alex Barachant and Jutten (2010)] is one such group who have successfully implemented frameworks for BCI using Riemannian Geometry. Using Riemannian Geometry has many benefits in studying the Human Central Nervous system (CNS). The CNS has approximately 10¹² neurons, whose 10¹⁵ synaptic connections release and absorb 10¹⁸ neurotransmissions and neuro-modulations per second and hence the human brain can be termed as one of the most complex and complicated objects. To record EEG, a set of electrodes are applied on the scalp so to establish electrical contact with the skin and in such a way to sample as evenly as possible the available scalp surface. Standard placements are based on the positioning on proportional distances along head anatomical landmarks. The 10-20 electrode system with 19 electrodes is the dominant standard (FIG. 5). In a 10-20 system every electrode placement location has a letter to identify the lobe of the brain it is reading the data from. These lobes or areas are: prefrontal (Fp), frontal (F), temporal (T), parietal (P), occipital (O), and central (C). FIG. 5 is a diagram of the electrode locations. There is no ‘central lobe’; due to their location, and depending on the subject wearing the system, the “C” electrodes can exhibit/represent EEG activity more typical of frontal, temporal, and some parietal-occipital activity. There are numbers associated with these lobes or regions for each position. Even numbered electrodes i.e., (2, 4, 6, 8) refer to electrode placement on the right side of the head and odd numbers (1, 3, 5, 7) refer to those on the left side. Right along the middle of the head, there are (Z) sites. A ‘Z’ (zero) refers to an electrode placed along the mid-line(sagittal) plane of the skull, (FpZ, Fz, Cz, Oz) and is present mainly for reference measurements. These electrodes do not necessarily reflect or amplify lateral hemispheric cortical activity as they are placed over the corpus callosum, and do not represent either hemisphere adequately. “Z” electrodes are often utilized as ‘grounds’ or ‘references’.

### II. Hybrid EEG Control Systems Using Riemannian Classifiers for Assistive Mobility

A current focus is on non intrusive signal processing method. These are methods in which the signals are extracted from the subject's scalp and do not need any surgical implant of the device(s). After measurement, the signal is processed, classified and commands generated. One of the most prominent usages of BCI is through Event-related potentials (ERPs). ERPs are the minute voltages generated in the structures of a functioning brain, in response to specific events or stimuli (Blackwood and Muir, 1990). ERPs can be seen as changes in EEGs when events occur relating to sensory (optical, auditory, nose, skin, etc), motor (hands, feet) and/or cognitive functions. EEGs provide noninvasive methodologies to study psycho-physiological and mental processes. ERPs reflect the consolidated activity of post-synaptic potentials produced when a large number (in the order of millions) of similarly oriented cortical pyramidal neurons fire synchronously while processing information [Cobb et al. (1995) Cobb, Buhl, Halasy, Paulsen, and Somogyi].

Human brain ERPs are normally divided into 2 categories; Sensory and Cognitive. During sensory, the waves (which are early) peak approximately within the first 100 milliseconds after stimulus and they depend mainly on the physical parameters of the stimulus and they are also termed exogenous. Examples are Visually Evoked Potentials (VEP). In contrast, the cognitive ERPs generated during later parts depend on how the subjects evaluate the stimulus and they are also termed endogenous ERPs as they examine information processing. The waveforms are described according to latency and amplitude. Examples are P50, N100, P200, N200, N300, P300, N400 and P600. We study P300. There are advantages and disadvantages in both the sensory and cognitive types of EEG. These pros and cons may span across accuracy, speed and system complexity. Steady State Visually Evoked Potentials (SSVEP) have high Information Transfer Rate (ITR), very little training duration and very good response times (short) and their disadvantages are visual fatigue when using them, false positives in certain bands.

P300s have the following advantages; occurrence of the signal between 250 ms to 350 ms after the event, some of the lowest user training needed, not robust to fatigue, motivation, attention levels and other non-stationarities [Wolpaw et al. (2002) Wolpaw, Birbaumer, McFarland, Pfurtscheller, and Vaughan] in the subjects' brain, system calibration is a must since P300 depend on the user's unique EEG patterns. These challenges in P300 might prompt the development of expensive systems. SSVEP can be integrated with P300 to exploit the benefits in both paradigms.

Steady State Visually Evoked Potentials. The brain activity modulations that occur in the visual cortex after receiving a visual stimulus is termed as VEP. SSVEPs are elicited by the visual stimuli that have a steady intensity and the stimulus frequency changes will usually be higher than 6 Hz [Wu et al. (2008)]. If the stimulus is a flash, a signal which is sinusoidal waveform is observed and its fundamental frequency will be same as the stimulus blinking frequency. In cases where the stimulus is a pattern, the SSVEP occurs at a rate which is similar to its reversal, at their harmonics [Zhu et al. (2010) Zhu, Bieger, Molina, and Aarts, Perlstein et al. (2003)]. In contrast to TVEP, the discrete frequency components of SSVEPs remain fairly constant in amplitude and phase relatively longer periods. [Galloway (1990)]. However, one of the advantages are that the SSVEPs are less susceptible than TVEPs to artifacts produced by blinks and eye movements and to electromyographic noise contamination [Perlstein et al. (2003)].

SSVEP can be observed in the human occipital region when the BCI users focus their gaze on flickering objects, whether a screen or LED light bulbs or similar items that can emit light at selected frequencies. SSVEP based BCIs can also be used to allow users to select a different targets by means of a focus or gaze variation, i.e., focus on different frequency stimuli. The user visually fixes attention on a target and the BCI can identify the target by means of SSVEP feature-analysis. When we consider BCI as a communications channel, SSVEP-based BCIs can be classified into three categories depending on the specific stimulus sequence modulation in use [Bin et al. (2009)]: time modulated VEP (t-VEP) BCIs, frequency modulated VEP (f-VEP) BCIs, and pseudorandom-code modulated VEP (c-VEP) BCIs. VEPs that react to different stimulus sequences will be orthogonal or near orthogonal with each other in some domain to ensure reliable identification of the target [Bin et al. (2009)].
In a t-VEP BCI, the flash sequences of different targets are orthogonal in time. That is, the flash sequences for different targets are either strictly non overlapping or stochastic.
In an f-VEP BCI, each target is flashed at a unique frequency, generating a periodic sequence of evoked responses with the same fundamental frequency as its harmonics.
In a c-VEP BCI, pseudo-random sequences are used. The duration of ON and OFF states of each target's flash is determined by a pseudo-random sequence. Signal modulations can optimize the information transfer rate. Indeed, code modulation provides the highest communication speed.

The typical VEP-based BCI application displays flashing stimuli, such as geometric forms, digits or letters, on a screen to induce SSVEPs while the user stares at one of the symbols. The user can move their gaze to the flashing digits or letters, in order to communicate with the computer [Lee et al. (2008)]. The advantage of this type of control signal is that very little training is required. However, the user will experience screen fatigue which can be attributed to the user focusing on a screen location. This type of control signal can only be used for exogenous BCIs. Due to this drawback, VEPs are not suitable for patients in advanced stages of Amyotrophic Lateral Sclerosis (ALS) or with uncontrollable eye or neck movements (ticks). Some research using SSVEP-based BCIs that are controlled by the attention of the user [Allison et al. (2008); Zhang et al. (2010)] to overcome this drawback were performed by Allison et. al. and Zhang et. al.

Any form of a display system can elicit SSVEP, although some are better than others. Liquid Crystal Diode (LCD), Cathode Ray tube (CRT), Light emitting Diode (LED) are some of them. The display systems using these technologies could be a flat screen, tablets, mobile phones, etc. These surfaces assist with the SSVEP simulations. LCD and LED based simulators are better than CRT, but need more complex technology to display. LCD screens are optimal for low complexity BCI (less than 10 choices), since the subject's eyes get tired if CRT is used in such cases. For medium complexity BCI (10-20 choices), LCD or CRT screens are optimal. LED screens are a preferred choice for complex BCI (more than 20 commands) [Nicolas-Alonso and Gomez-Gil (2012)].

P300. The P300 wave was discovered by Sutton et. al. in 1965 and it has been a major component in the area of ERP research. The P300 latency ranges between 250-350 mSecs when auditory stimuli are provided for most adult subjects between the ages of 20 and 70 years. P300 is considered as one of the most reliable multi-command ERP systems. The oddball paradigm has been used extensively in research areas, to stimulate the P300, although there are many others available. In the oddball experiments, different stimuli are presented at the same interval as part of a trial continuously, except one of them which occurs relatively infrequently compared to others and this is the oddball. During this experimental process, the subject is instructed to respond only to the infrequent or target stimulus and not to the frequently presented or standard stimulus. Farell, Donchin et. al. (1986) performed a detailed study of the P300 paradigm. Allison et. al. (2012) developed a continuous stimulus system using P300, which has been extensively utilized in research.

Hybrid BCI. SSVEP based BCIs generate weak SSVEP signals when used with a computer monitor for visual stimulus and they cannot make use of the harmonic frequencies. On the other hand, P300 based BCIs can utilize several sequences of visual stimulus and these issues can potentially decrease the information transfer rate (ITR).

As mentioned previously, we can elicit SSVEP when a subject focuses on a target flickering at a constant frequency. Because SSVEP has spectral peaks at the harmonics of the stimulation frequency [Herrmann (2001)], targets flicker at non harmonic frequencies in SSVEP based BCIs (e.g., if 8 hz is the main (harmonic) frequency, the other flickers should not flicker at the sub harmonic frequencies i.e., 16 hz, 24 hz etc). SSVEP-based BCIs are fast and reliable, and need little subject training [Lesenfants et al. (2014)]. A drawback of using this is the limited availability of frequencies for providing both stimulation and feedback without an additional device, the number of targets is limited by the monitor's refresh rate [Volosyak et al. (2009)]. Furthermore, the monitor stimulated SSVEP peak is weaker than that evoked by light-emitting diodes (LEDs) [Güneysu and Akin (2013)]. These limitations reduce the information transfer rate (ITR).

On the other hand, the P300 potential is elicited approximately 300 ms after a subject spots an infrequent target [Polich (2012)]. This is employed in the oddball paradigm and is commonly used for P300-based BCIs. This system presents an infrequent target stimulus usually in the background of frequent standard stimuli. Normally, P300-based BCIs have several targets which can increase ITR when compared with the proportion of the number of targets. However, The repetitive nature of the stimulation sequences in P300-based BCIs need repetitive to average ERPs, increases the stimulation time and hence reduces the overall ITR [Farwell and Donchin (1988)]. We review a hybrid EEG integrating SSVEP and P300. This is because, a hybrid EEG brings out the best from both the systems and reduces the ITR challenges [Allison et al. (2012); Riechmann et al. (2011); Su et al. (2011); Rebsamen et al. (2008); Punsawad et al. (2010); Edlinger et al. (2011); Panicker et al. (2011); Panicker].

Several researchers have studied the area of Riemannian Geometry for BCI; M Congedo, A Barachant et. al. [Alex Barachant and Jutten (2010)] is one such group who have successfully implemented frameworks for BCI using Riemannian Geometry. Using Riemannian Geometry has many benefits in studying the Human Central Nervous system (CNS). The CNS has approximately 10¹² neurons, whose 10¹⁵ synaptic connections release and absorb 10¹⁸ neuro-transmissions and neuro-modulations per second and hence the human brain can be termed as one of the most complex and complicated objects. Arranging the measurements at N electrodes in a vector, the potential can be written as a function of time such as

$$x ( t ) = {x}_{s} ( t ) - {x}_{r} ( t ) ∈ {ℜ}^{N} \qquad ( 3.1 )$$

where s is the scalp and r denotes the respective reference leads. It needs to be noted that the time is sampled at regular intervals, in the order of tens or hundreds or thousands of samples per second. Analog-to-digital (A/D) conversion proves that the sampling rate must be at least twice the maximal frequency contained in the sampled signal [Kirkhorn (1999)], hence care should be taken appropriately to set the low-pass filter during data acquisition accordingly.

Since the diploar conduction activity is linear and instantaneous as discussed in equation: (3.1), we can observe that each electrode on the scalp outputs a weighted sum of the underlying source inputs. Hence the covariance matrix of EEG data is highly non-diagonal, meaning that the EEG channels are highly correlated and this property is exploited in many of the EEG studies.

M. Congedo et. al. have discussed in detail usage of Riemannian Geometry in the area of BCI [Alex Barachant and Jutten (2010)]. The physiological and environmental condition variability. The challenges mentioned above give rise to 3 prominent needs from the BCI:
1. Improvement in usability conditions: Studies in the areas of physiology, anatomy, cognitive and emotional factors that may lead to improvements of the performance and usability, such as the motivation provide proof of the robustness to noise and the simple implementation of Riemannian Geometry in the area of BCI.

Some are highlighted in the works of researchers as seen in the below citations: [Allison et al. (2012); Schomer and Da Silva (2012); Kubler et al. (2001); Zander et al. (2010), Wolpaw and Wolpaw (2012)].

At present, there are areas of active research that are trying to overcome inter-subject and empathy of the user in P300 spellers [Makeig et al. (1997)].
2. Increase in robustness of BCI systems is of great importance in the present research community [Brunner et al. (2015)]. This topic is of importance in this research area and details are provided further. Deficiency in robustness of a BCI system has been a major contributor to the lack of usage of a BCI system. A less robust system is often considered a less reliable system. The former is a traditional subject of study in the field of human-machine interaction (HMI).

An important area of EEG is the selection of the right band type for the task at hand [Congedo et al. (2011)]. The prominent EEG bands and their details include: Delta (0.5-4 Hz), Signifies sleep, dreaming, REM cycles. Occurs when we enjoy restorative, deep, dreamless sleep; Theta (4-8 Hz) Signifies deep relaxation, creativity, insight, reduced consciousness. They can be picked up during day dreaming and deep meditation; Alpha (8-13 Hz) Signifies physical and mental relaxation. They occur when subject's eyes are closed, when artistic, yogic mentally relaxed practices are being done; Beta (13-32 Hz) Signifies normal alert consciousness and active thinking. It occurs when one is focusing on work, solving a problem, learning a new concept, or engaging in active conversation; Gamma (32-100 Hz) Signifies heightened perception, learning and problem solving tasks, as well as alertness and it typically occurs when information is processed simultaneously in multiple parts of the brain.
3. Property based improvement of the BCI interface [Villringer and Chance (1997), Toronov et al. (2003); Freeman (1975)]: For BCI based on P300 these lines of research have led to, inter-varia, automatic pause detection [Berger (1929)], the use of faces for flashing symbols [Cohen (1972)], the use of random groups or pseudo-random groups flashing instead of row-column flashing [Sutton et al. (1965); Wolpaw et al. (2000), Birbaumer et al. (2003)], the dynamic stopping of flashing sequences [Fabiani et al. (1987)], etc. For SSVEP-based BCI improvements of the interface include the use of precise tagging of the flickering so as to use phase information [Farwell and Donchin (1988)] and the use of smart flickering sequences such as code modulation [Lange et al. (1997)], multi-phase cycle coding [Donchin et al. (2000)].

The research community has developed various applications of EEG based BCIs, such as: cursory control on the screen [Wolpaw et al. (1991); Allison et al. (2012)], virtual keyboard letter, digit selection [Hong et al. (2009)], Internet browsers [Muglerab et al., Karim et. al. (2006), Bensch et al. (2007)] and computer games [Krauledat et al. (2009); Krepki et al. (2007)]. Recently, BCIs based on EEG signals have been used to control wheelchairs to help bring mobility back to some severely disabled people Rebsamen [Rebsamen et al. (2007)]. The community has also developed systems using the 2 broad methods of wheelchair control namely: Translating user intention into navigation commands (acceleration, braking, turning left, turning right and similar motion) in order to control a wheelchair [Tanaka et al. (2005); Rebsamen et al. (2007); Choi and Cichocki (2008)]. The second task could be one which selects a desired destination using BCI, from a list of available destinations and then command an autonomous control system to drive the wheelchair to reach the desired destination [Rebsamen et al. (2010)]. Since P300-based BCI systems are more suitable to output more commands as compared to SSVEP based and ERD-based BCI systems and have a relatively high level of accuracy, these BCIs have been predominantly used for destination selection assignments [Iturrate et al. (2009)].

The improvement of the BCI interface by studying its properties [Allison et al. (2012); Y. Li and Lee (2014); Y. Li and Johnson (2010)]. Specifically for P300-based BCI these lines of research have led to, inter-varia, the introduction of language models for letter and word prediction [Throckmorton and Collins (2013); Mainsah and Throckmorton (2013); Kaufmann et al. (2012); Kindermans and Schrauwen (2013)], automatic pause detection [Pinegger (2014)], the use of facial imagery for flashing symbols [Kaufmann et al. (2012)], the use of random groups or pseudo-random groups flashing instead of row-column flashing [Congedo et al. (2011), Townsend et al. (2010); Brunner et al. (2015)], the use of inter-stimulus intervals randomly drawn from an exponential distribution instead of constant [Congedo et al. (2011)], the dynamic stopping of flashing sequences [Kindermans and Schrauwen (2013)], etc. For SSVEP-based BCI improvements of the interface include the use of precision technology:
1. There are several types of BCI systems that are implemented in the Research community. Riemannian Geometry is being sought after in decoding data in BCI due to its versatility in reducing the dimensions in large multi dimensional systems. A BCI consists mainly of 2 major components: the participant and the computing system.
2. The Computing system comprises of an interface and a decoder. The interface can be any computer application that provides a continuous feedback to the participants, while they perform their set of actions. The decoder mainly translates the participants' brain signals into machine executable commands.
3. We find that the destination selection problem is similar to a spelling problem. These spellers have demonstrated their success since their introduction in the late 1980s by Farwell et. al. [Farwell and Donchin (1988)]. They proved that severely disabled users could use this technology [Sellers et al. (2006), Nijboer et al. (2008)]

As part of this research, we will look at two of the most famous EEG Paradigms 1. EEG-P300 and 2. EEG-SSVEP. We will look into some of the workings of these two paradigms and also the research performed by some of the experts.
1. EEG-P300. The P300 speller is the most researched and exploited implementations of the P300 [Rezeika et al. (2018)]. This system has letters and symbols in the form of a matrix wherein every row/column combination is displayed in an intensified manner, in a random sequence [Farwell and Donchin (1988)]. Although P300 technology is over 40 years old, recent research has picked up pace in the areas of optimizing the classification algorithms [Krusienski et al. (2006)], better placement of the EEG electrodes [Krusienski et al. (2008)] and the electrode quality, the stimulation color and intensity [Covington and Polich (1996)], data matrix [Allison and Pineda (2003)] size, and other similar areas. One of the most prominent challenges of P300 is that it occurs amongst other EEG activities and it is relatively weaker than those activities and it takes more than 5 repetitions in order to extract a reliable P300 potential.

The P300 speller is a dictation computational system that is controlled through the ERPs based on P300, which is a cognitive brain response elicited by the stimulation-dependent (synchronous) oddball paradigm [Wolpaw et al. (2002); Wolpaw (2013); Donchin and Coles (1988), Pires et al. (2012); Guger et al. (2009)]. The P300 speller is one of the most implemented BCIs, normally a stimulation screen has solid black color background with a symmetric matrix of stimulation markers which are usually the 26 English alphabet characters, nine integer digits, and underscore for blank space.

The stimulus consists of markers that flash in a random sequence mode or multimarker random sequence modes. At that time, when the users perceive a flash stimulus on the symbol to which they are focused on, a P300 ERP is elicited [Wolpaw (2013), Donchin and Coles (1988)]. The conventional spelling task process relates an automatic detection of the P300 to the letter that generates it [Wolpaw et al. (2002); Wolpaw (2013), Donchin and Coles (1988), Pires et al. (2012); Guger et al. (2009)].

Recent updates to the P300 speller include matrix size, marker arrangement, marker types, stimulus sequence, and stimulus presentation and have been tested to increase the information transfer rate and the detection rate and even to perform non-spelling tasks. A summary of these variations is described next, to contextualize the stimulation screen presented in this work. Detection and transfer rates equivalent to the conventional P300 speller was developed by Sellers et. al. (2006) by using a matrix and estimated the optimal Interstimulus Interval (ISI) and Stimulus Duration (SD). Colwell et. al. (2014) developed a 9×8 rectangular matrix, while Jin et. al. (2012) used 7×12, and Shi et. al. (2012) utilized rectangular speller matrices of 6×12. Regarding the stimulus presentation, blue/green color scheme of stimulation markers for nonflashing/flashing states [Farwell and Donchin (1988); Ikegami et al. (2012); Takano et al. (2009); Takano et al. (2014)], and face paradigm [Farwell and Donchin (1988); Jin et al. (2012); Halder et al. (2015); Kaufmann et al. (2011); Jin et al. (2013)]. Furthermore, all these variants had a solid black color as background. Screen sequences were displayed instead of events flashing, in the geometric variation named Geospell [Aloise et al. (2013)]. Each screen contains six characters in a circular arrangement, whose center has a cross symbol where the subjects focus their attention. Each group of six characters present corresponding to the matrix rows and columns of a conventional speller. The background has remained solid black for all these speller variants, just as in the conventional speller. We explore the possibility of using P300 with destination images, that the user selects in order to navigate to them.
2. EEG-SSVEP. The brain activity modulations that occur in the visual cortex or occipital cortex after receiving a visual stimulus is termed as VEP [Nicolas-Alonso and Gomez-Gil (2012); Baseler et al. (1994); Wang et al. (2006)]. These modulations are relatively easy to detect since their amplitude increases rapidly as the stimulus is moved closer to the central visual field.

VEPs may be classified according to three different criteria [Odom et al. (2004); Yin et al. (2009)]: (i) by the morphology of the optical stimuli, (ii) by the frequency of visual stimulation; and (iii) by field stimulation. According to the first criterion, VEPs may be caused by using flashing stimulations or using graphic patterns such as checkerboard lattice, gate, and random-dot map etc.

When we classify VEPs according to the frequency, we may have transient VEPs (TVEPs) and as steady-state VEPs (SSVEPs). When the frequency of visual stimulation is below 6 Hz, we can see the occurrence of TVEP, while SSVEPs occur in reaction to stimuli of a higher frequency [Baseler et al. (1994); Odom et al. (2004); Yin et al. (2009)].

Lastly, VEPs can be divided into whole field VEPs, half field VEPs, and part field VEPs depending on the area of on-screen stimulus. For instance, if only half of the screen displays graphics, the other half will not display any visual stimulation, and the person will look at the center of the screen, which will induce a half field VEP. TVEPs are typically not used for BCI. Throughout this Study, we concentrate on SSVEP, since TVEP needs a change in the visual field, which could add an additional uncertainty and reduced inaccuracy.

When SSVEPs are elicited by the same visual stimulus, at frequencies higher than 6 Hz. When the visual stimulus is a flashing light, SSVEP shows a sinusoidal waveform, the base frequency of which is the same as the blinking frequency of the stimulus. If the stimulus is a pattern, the SSVEP occurs at the reversal rate and at their harmonics [Zhu et al. (2010); Perlstein et al. (2003)]. In contrast to TVEP, constituent discrete frequency components of SSVEPs remain closely constant in amplitude and phase over longer periods of time [Galloway (1990)]. SSVEPs are also robust to artifacts produced by blinks and eye movements [Perlstein et al. (2003)] and to electromyographic noise contamination, which is contrast to TVEPs.

Any form of a display system can elicit SSVEP, although some are better than others. Liquid Crystal Diode (LCD), Cathode Ray tube (CRT), Light emitting Diode (LED) are some of them. The display systems using these technologies could be a flat screen, tablets, mobile phones, etc. These surfaces assist with the SSVEP simulations. LCD and LED based simulators are better than CRT, but need more complex technology to display. LCD screens are optimal for low complexity BCI (less than 10 choices), since the subjects eyes get tired if CRT is used in such cases. For medium complexity BCI (10-20 choices), LCD or CRT screens are optimal. LED screens are a preferred choice for complex BCI (more than 20 commands) [Nicolas-Alonso and Gomez-Gil (2012)].

### Research Problems in Mobility Systems.

During a literature review, we analyzed that the needs of the community pertinent to the topic of smart assistive mobility systems can be met broadly by the following topics:
1. A limited or no calibration system, which can be used to improve usability [Alex Barachant and Jutten (2010)]. In fact this is a sought after usability need in the community. Generic model classifiers and/or domain adaptation methods are developed, which allow learning while data from other modules/sessions and/or other subjects are used to start without calibration and increase performance. This is termed as smart initialization, which is a user based initialization option.
2. Online adaptive classifiers These classifiers enable the classification of the signals while the system is being used and are very effective in realtime usage. Examples are SSVEP based mobility systems that control wheelchairs, smart devices etc.

### Techniques for EEG Analysis

Every term in cross spectral density (CPSD) [Alex Barachant and Jutten (2010)] gives reference to an important component of the CPSD. Cross refers to two signals that are across from each other. Spectral refers to the frequency aspect of the CPSD. If we consider a rainbow; the distribution of light across a spectrum of colors or in turn wavelengths thereof. Density refers to the power in a band of frequencies from frequency f1 to f2 which is located under the CPSD curve in the related band.

Spectral density is useful in detecting the correlation between two signals. The relationship between the two signals can be efficiently expressed in the frequency domain using cross power spectral density (CPSD). This relationship between the two time series are determined as a function of frequency. It is logical to state that statistically significant peaks at the same frequency can be seen in two time series and we can try to see if their periodicity are related with each other. If that is the case, what is the phase relationship between them. In addition to signals with peaks, we can also perform cross spectral analysis in the absence of peaks in the power spectrum. If we have two time series wherein the power spectra of both of them are not distinguishable from the noise, how can the cross-spectral analysis still be able to finalize the accurate frequencies? The answer lies in the coherent modes at certain frequencies. In a noisy EEG signal, CPSD can also be useful in identifying the frequency response; say, if there is no correlation between the noise and the input or output of the system, its frequency response can be identified from the signal's CPSD of the input and output.

Using the above theories, we have successfully detailed the effect of noise in our signals using CPSD. Phase noise and amplitude noise were detected and documented. EEG signals are inherently noisy and sometimes depending on the paradigm, uncertain. CPSD has proven that the detection and classification algorithms that uses its logic, can benefit from the improved spectral estimation and frequency resolution.

The analysis from CPSD will lead us to the following details:
1. Zero CPSD relates to uncorrelated signals.
2. Flat and non zero CST relates to the signals being uncorrelated and the two signals may be the same or very similar.
3. Main lobe in the CPSD the pair of signals have some correlation. Narrow lobe means higher correlation and wider lobe means more uncorrelated the pair of signals.
4. CPSD spike at a frequency(Fi) hertz indicates that the signals are periodically correlated every 1/Fi seconds. This could also be due to resonance in frequency at Fi.
5. A flat CPSD means mostly uncorrelated signals.
6. Large single spike at zero hertz means a large DC offset in both the signals.
7. Medium with main lobe means the samples in signal 1 are correlated with other samples and the correlation reduces with separation in time.

Typically there are five medically established EEG rhythms, i.e. delta (δ) (0 to 4 Hz), theta (θ) (4 to 8 Hz), alpha (α) (8 to 13 Hz), beta (β) (13 to 30 Hz) and gamma (γ) (30 to 60 Hz). Well known feature extraction techniques like Principal component analysis (PCA), independent component analysis (ICA) and linear discriminant analysis (LDA) have been used for several decades. As part of this study, we restrict our research to the beta eeg signals. We had the subjects focus on a flickering image and think of a mathematical equation to increase their alertness. The flickering was 8.1, 11.1, 12.1 and 15.1 Hz frequencies.

Coherence Function. Noise is one of the most common issues with signal processing. It is an inherent property of most of the signals. Magnitude square coherence is a process of estimating how a signal corresponds with another at the given frequencies. It is also termed as normalized CPSD, which is given by:

$${𝒞}_{xc} ( f ) = \frac{{\vert {𝒯}_{xy} ( f ) \vert}^{2}}{{𝒯}_{x} ( f ) {𝒯}_{y} ( f )} \qquad ( 3.2 )$$

Where: Tx(f) and Ty(f) are the PSDs based on auto correlation of the x(t) and y(t) signals respectively. Due to the above properties and function possibilities, CPSD can be used on EEG, ECG and other human performance signals.

Infinite Smoothing Filter. We design a simple infinite filter such that the known input to the filter x(t) gives the known output y(t). We design the filter and the filter impulse transfer function h(t). The goal is to keep the mean squared error minimum;

$${ℛ}_{xy} ( τ ) = h ( τ ) ⊗ {ℛ}_{y} ( τ ) \qquad ( 3.3 )$$

applying FFT on the above equation, we get:

$${𝒯}_{xy} ( f ) = ℋ ( f ) {𝒯}_{y} ( f ) \qquad ( 3.4 )$$

CPSD Txy(f) and PSD Ty(f) is calculated for output signal y(t).

The transfer filter can be calculated by:

$$ℋ ( f ) = \frac{{𝒯}_{xy} ( f )}{{𝒯}_{y} ( f )} \qquad ( 3.5 )$$

CPSD is used in our calculations to design the infinite smooth filter.

Band-Pass filter. We will discuss a type of band-pass filter called the inference filter, which can be used to efficiently filter the EEG signal and stop the signals that are outside a set of values; i.e., all frequencies between the defined lower and upper frequency limits are passed and others stopped. In this case the filter is 7-23, any signals with frequency<7 or <23 will not pass through. Hence the signals are restricted to be between 7 and 23.

As part of this research, we review several paradigms including but not limited to P300, SSVEP and so on and we also briefly touch upon Riemannian geometry based algorithms and investigate the options of integrating EEG Paradigms P300 and SSVEP. We find that both these paradigms have complementing properties that can be exploited to enhance the functioning of a cognition controlled assistive mobility system. A few of the EEG hardware namely OpenBCI Cyton and Emotiv Epoc have also been surveyed and found that their performance is inline with expectations and as mentioned on the vendor's technical information pages.

A hybrid system can be implemented on a smart system, e.g., a wheelchair. This will be implemented in a known environment so that it can be further studied. The mobility system is a power wheelchair that is connected to a sabertooth 2×32 motor controller and a computing system. The perception is handled by a stereo camera and 2D liDAR. The cognition control is handled by a Brain Computer Interface (BCI) using electroencephalography (EEG).

Brain Computing Interface. One example of a BCI consists of the following hardware components. Openbci Cyton: The OpenBCI Cyton is a Biosensing board that contains at its core, a PIC32MX250F128B Microcontroller with a pre-flashed chipKIT UDB32-MX2-DIP bootloader. It contains a LIS3DH 3 axis Accelerometer and RFduino BLE radio for communication. Its an Arduino-compatible, 8-channel neural interface with a 32-bit processor. The PIC32MX250F128B microcontroller, gives it adequate amount of onboard memory and fast processing speeds. Using the basic serial communication, the data is sampled at 250 Hz. Brain activity Electro Encephalography (EEG), muscle activity (EMG), and heart activity (ECG) are the data that the OpenBCI Cyton Board is capable of sampling. The board can communicate wirelessly to a processing unit like a PC, Raspberry PI or Nvidia tegra systems, etc, via the OpenBCI USB dongle using RFDuino radio modules. Mobile device or mobile tablet communication compatibility is achieved wirelessly if they are equipped with Bluetooth Low Energy (BLE) technology. Wifi connectivity can also be obtained using the OpenBciWifi Shield. We choose only the EEG signals for this research and filter out other anomalies using signal preprocessing techniques.

Another leader in user friendly consumer grade EEG equipment is Emotiv Epoc [Williams et al. (2020)] range of headsets. They are very useful for ERP related signals and to some extent VEP. These two headsets can be coupled for both P300 and SSVEP. Emotiv EPOC+ does not have many sensors in the occipital region and this is where we can couple OpenBCI ultracortex occipital region headset with the Emotiv Epoc.

Mobility Integration System. This module comprises of the computer that enables integration of the BCI with the wheelchair/mobility system. We use a Nvidia Tegra system as the integration system. This will house the EEG software that makes the BCI function, the motor controller and the ROS control software packages that are essential for controlling the wheelchair.

Smart Assistive Mobility System. The Smart mobility system can be a Jazzy Select power wheelchair that has compatibility with the Sabertooth 2×32 motor controller.

### III. Asynchronous SSVEP Based BCI Implementation

This research can be broadly classified into modules: Destination Selection System using SSVEP, Mobility Integration System, Assistive Mobility System.

Destination Selection System using SSVEP. We implement an intelligent mobility system that will be used to assist persons will severe motor disabilities. A SSVEP BCI system will be trained such that the user will focus on destinations images that the wheelchair will navigate to. The operator does not need to have any prior knowledge of BCI or SSVEP or can be BCI-blind.

We detail the SSVEP system in the following subsections. Several research have contributed to BCI decoding and Conventional BCI Decoders broadly have the following modules [Colwell Throckmorton Morton (2013)]: (i) Signal extraction, (ii) Pre-processing, (iii) Feature extraction and selection, (iv) Classification.

Signal extraction. This module enables the measurement and extraction of the signals from the subjects scalp. We use BCI systems to facilitate this. We choose to use OpenBci as it is an open hardware system and is quite versatile. At the heart of the BCI signal extraction unit is the OpenBci Cyton processing board. This has powerful microcontrollers on them which include most up-to-date OpenBCI firmware to interface with the on-board ADS1299, Accelerometer, and SD card. The Cyton BCI Board is an 8 channel biosensing amplifier that can measure ECG, EMG, and EEG. It connects to a computer wirelessly with a WifiShield board. The Cyton can stream data up to 16 KHz with data sampling at 250 Hz. To double the number of electrodes, we could have used the Cyton+Daisy, which increases the number of electrodes to 16, and can stream data up to 8 KHz while the data sampling will be 125 Hz. But since we found that 8 electrodes are sufficient, we chose not to use the Daisy board. We found the sampling rate inadequate for our research and hence added a WifiShield to the list and sampling rate can be up to 1 KHz. We used the Cyton board with the basic 8 channels coupled with the WiFi Shield and could stream data easily up to 12 KHz, although their site boasts transmission rates up to 16 KHz. Using Cyton coupled with the Daisy board and WifiShield, sampling rate was 8 KHz. For transmission, we control the WiFiShield through HTTP requests and can send JSON objects with data in nano volts.

Initially we used the flat electrodes for signal extraction with conducting gel used as a conducting medium between the user's scalp and the sensor top and measured the EEG signals. We used a combination of OpenBCI and OpenViBE to measure realtime signals and for real-time processing of the same. It was seen that the signal strength was inadequate due to the presence of hair in several of the subjects and hence opted to a better type of electrodes, which are dry but have blunt spikes that can go through the human hair and still get a decent signal strength with limited noise.

In order to extract the EEG signals as part of the SSVEP paradigm, we need to provide a stimulus to which the SSVEP signals are generated. The subject who commands the smart systems using their cognition will stare at the screen with the stimulus. This induces or entrains the brain waves in the occipital region of the brain.

Pre-processing. EEG data reads are often mixed with artifacts or signals that are not generated by the brain but are still recorded in the EEG measurements. These can also be termed as the noise that many times mimic the objects of interest like the SSVEP output read in the occipital region, or the cognitive measurements that are measured on the forehead and other parts of the skull. The BCI Engineer was aware of the logical topographic distribution field for real EEG abnormalities to distinguish the artifacts from the actual brain waves. Typically some of the artifacts are physiologic in nature and are present due to eye movements, shivers, sniffing, sneezes, coughs, swaying, EKG, pulse and so on and others could be due to the 60/50 Hz artifacts, seat/bed/other furniture movements, loose electrodes or wiring and so on. This module involves addition of band-pass filters to remove signal errors/noise due to outliers, which is useful since broadly we are concerned only with frequencies within the band of 8-31 Hz. After the application of filters between 8 and 31, several noisy signals were removed. We also implemented Independent Component Analysis (ICA) to transform the acquired brain signals to its purer-form by eliminating/reducing artifacts, reduce the ongoing brain activity and enhance the primary signal components. Fast Fourier Transform is useful in several preprocessing techniques. Power Spectral Density (PSD) is one such wherein [Bach and Meigen (1999)] can be used.

Feature extraction and selection. After the implementation of ICA, we obtained 2 sets of signal components i.e., artifact components and required components. Artifacts comprise of rhythmic eye blinks and unexpected sudden body movements. These are discarded from the processed signals, while the required components that form the actual signal components are saved and re-used during this feature extraction stage. The required features are extracted and then selected from the signal band. These individual signals are next classified based on the event that occurred at that time.

EEG Classification. After the features are extracted and selected, we use Riemannian Geometry based algorithms to train and classify the signals accurately. Training the Detection and classification machine learning modules comprises of using Riemannian minimum distance to mean (RMDM) classifier for the BCI. RMDM is a well researched classifier that is deterministic, transfer learning capable, robust to noise, computationally effective and efficient and at the same time simple to implement. A fundamental implementation using the geometric mean in the Riemannian manifold for symmetric positive definite (SPD) matrices is very efficient as researched by Congedo et. al. (2011). RMDM works as follows: (1) Obtain SPF matrices from the Dataset, (2) Calculate and encode BCI trails for the available classes, (3) Estimate center of mass of the trials for each class, (4) Test mode enables encoding a BCI trial same way as an SPD matrix, (5) Assign the trial to the class whose center of mass is the closest based on an accurate distance function acting on the manifold, (6) Select an appropriate metric such that the metric determines both the distance function between two points and the center of mass for a cloud of points, this can be termed as the point on the Riemannian manifold such that it minimizes the dispersion of the cloud around itself, (7) Employ this in the efficient signal processing algorithm [Congedo et al. (2017)] for estimating the power means in a positive definite matrix.

Mobility Integration System. This module comprises of the computer that enables integration of the BCI with the wheelchair/mobility system. We use a Nvidia Tegra system as the integration system. This will house the EEG software that makes the BCI function, the motor controller and the ROS control software packages that are essential for controlling the wheelchair.

Smart Assistive Mobility System. The Smart mobility system is a Jazzy Select power wheelchair that has compatibility with the Sabertooth 2×32 motor controller. The wheelchair is a differential drive control system in which there are translational and rotational movements occurring at various velocities. Total translation occurs when both the wheels move at the same angular velocity and rotation occurs when the wheels move at opposite velocities. If only the right wheel moves with positive velocity, i.e., forward the wheelchair turns left and if only the left wheel moves with positive velocity, i.e., forward the wheelchair turns right. If the wheel moves in the reverse direction, the turns are in the opposite direction. The wheelchair differential drive dynamics follows that of a non-holonomic control system.

$$ω ( R + l / 2 ) = {V}_{r} \qquad ( 4.2 )$$

$$ω ( R - l / 2 ) = {V}_{l} \qquad ( 4.3 )$$

$$R = \frac{l}{2} \frac{( {V}_{l} + {V}_{r} )}{{V}_{r} - {V}_{l}} \qquad ( 4.4 )$$

$$ω = \frac{( {V}_{r} - {V}_{l} )}{l} \qquad ( 4.5 )$$

where l is the distance between the centers of the two wheels, Vᵣ and Vₗ are the right and left wheel velocities along the ground respectively, and R is the signed distance from the ICC to the midpoint between the 2 powered wheels. At any instance in time we can solve for R and ω. (1) If V1=Vr, then we have forward linear motion in a straight line. R becomes infinite, and there is effectively no rotation—ω is zero. (2) If V1=−Vr, then R=0, the wheelchair rotates about the midpoint of the wheel axis, the wheelchair rotates in place. (3) If V1=0, then the wheelchair rotates about the left wheel. In this case R=1 2. If Vr=0, the wheelchair rotates about the right wheel.

The wheelchair moves about using the 2 powered wheels whose center of rotation is CC—‘center of curvature’.

$$CC = [ x - R sin ( θ ) , y + R cos ( θ ) ] \qquad ( 4.6 )$$

at time t+δt

$$[ \begin{matrix}{x}^{′} \\ {y}^{′} \\ {θ}^{′}\end{matrix} ] = [ \begin{matrix}cos ( ωδ t ) & - sin ( ωδ t ) & 0 \\ sin ( ωδ t ) & cos ( ωδ t ) & 0 \\ 0 & 0 & 1\end{matrix} ] [ \begin{matrix}x - {CC}_{x} \\ y - {CC}_{y} \\ θ\end{matrix} ] + [ \begin{matrix}{CC}_{x} \\ {CC}_{y} \\ ωδ t\end{matrix} ] \qquad ( 4.7 )$$

This gives the motion of the wheelchair angular velocity ω, with distance R, around its CC. The wheelchair is very quick to move due to the changes in the velocity and hence sensitive. Changes in the velocity of the individual wheels can impact the trajectory.

The Inverse Kinematics of the autonomous wheelchair is given below:

$$x ( t ) = \frac{1}{2} {\int }_{0}^{t} [ {v}_{r} ( t ) + {v}_{l} ( t ) ] cos [ θ ( t ) ] dt \qquad ( 4.8 )$$

$$y ( t ) = \frac{1}{2} {\int }_{0}^{t} [ {v}_{r} ( t ) + {v}_{l} ( t ) ] sin [ θ ( t ) ] dt \qquad ( 4.9 )$$

$$Θ ( t ) = \frac{1}{l} {\int }_{0}^{t} [ {v}_{r} - {v}_{l} ( t ) ] dt \qquad ( 4.1 )$$

Some specific implementations of a differential drive wheelchair are: vl=vr=v which means that the wheelchair moves straight

$$[ \begin{matrix}{x}^{′} \\ {y}^{′} \\ {θ}^{′}\end{matrix} ] = [ \begin{matrix}x + v cos ( θ ) δ t \\ y + v sin ( θ ) δ t \\ θ\end{matrix} ] \qquad ( 4.11 )$$

vr=−vl=v which means that the wheelchair turns on a dime or it turns in place

$$[ \begin{matrix}{x}^{′} \\ {y}^{′} \\ {θ}^{′}\end{matrix} ] = [ \begin{matrix}x \\ y \\ θ + 2 v δ t / l\end{matrix} ] \qquad ( 4.12 )$$

The wheelchair moves as a combination of these two basic movements.

Hardware. One example of a BCI can consist of the following hardware components. (i) Openbci Cyton: for EEG-SSVEP related signals, (ii) Wifi Shield: for communication with the computer, (iii) UltraCortex Mark IV: for electrode placement in 10-20 montage.

Openbci Cyton: The OpenBCI Cyton is a Biosensing board that contains at its core, a PIC32MX250F128B Microcontroller with a pre-flashed chipKIT UDB32-MX2-DIP bootloader. It contains a LIS3DH 3 axis Accelerometer and RFduino BLE radio for communication. Its an Arduino-compatible, 8-channel neural interface with a 32-bit processor. The PIC32MX250F128B microcontroller, gives it adequate amount of onboard memory and fast processing speeds.

Using basic serial communication, the data is sampled at 250 Hz. Brain activity Electro Encephalography (EEG), muscle activity (EMG), and heart activity (ECG) are the data that the OpenBCI Cyton Board is capable of sampling. The board can communicate wirelessly to a processing unit like a PC, Raspberry PI or Nvidia tegra systems etc, via the OpenBCI USB dongle using RFDuino radio modules. Mobile device or mobile tablet communication compatibility is achieved wirelessly if they are equipped with Bluetooth Low Energy (BLE) technology. Wifi connectivity can also be obtained using the OpenBci Wifi Shield. The main input to the OpenBCI system is through the Ultracortex headset.

Dataset. Training datasets from “Laboratoire d'IngAcnierie des SystAšmes de Versailles” have been used in this research. The Dataset comprises of a EEG data collected across 9 subjects with the Events and the Resulting signals. We use Python programming language modules to read and pre-process the individual files and then process them with the RMDM and RMDMF algorithms. To enhance the training dataset we recorded data from additional 6 healthy subjects, (4 adult women, 2 adult men; age range 18-29 years, mean=19.7, StandardDeviation=2.9) were selected for data collection. All subjects were acquaintances of the author and were free of neurological or psychiatric disorders or medications known to adversely affect EEG recording. None of the subjects had prior experience with EEG recording or BCIs. We explained the purpose and procedures of the study to each subject before preparing them for the EEG recordings. The entire data set collected from the subjects are reported below. The experiments were conducted to measure the performance of the SSVEP BCI Classification. The performance parameters were the accuracy of the selected value and speed of selection. Datasets from “Laboratoire d'IngAcnierie des SystAšmes de Versailles” have been used as part of the training and this is a result of recordings from 6 subjects. In addition to this, SSVEP training data recording from 6 willingly participating subjects have been recorded to supplement the old dataset.

Navigation. After the destination has been selected by the user, the wheelchair navigation system localizes the wheelchair. The a priori map created using RTabMap is used as a map for the system. The wheelchair scans for obstacles and if there are obstacles in front, takes evasive action to avoid the obstacles. The main sensors used in this process are the RPLidar 2D lidar [A1( )] and Intel Realsense D435i stereo camera [Realsense D435]. Typical autonomous navigation involves a vehicle can plan its path and execute its plan without human intervention. We use this in the navigation of the wheelchair as well. The smart wheelchair, an autonomous robot can be termed as one that not only can maintain its stability as it moves but also can plan its movements. Each sub-system of autonomous navigation that we have developed is detailed below.

Mapping. The task of mapping senses the environment that the robot operates in and provides data to analyze it for optimal functioning. It is also a process of establishing a spatial relationship among stationary objects in an environment. Efficient mapping is a crucial process that gives rise to accurate localization and driving decision making. Usage of LiDARs for mapping is beneficial as they are well known for their high-speed and long-range sensing and hence long-range mapping, while cameras RGB, RGB-Depth are used for short-range mapping and also used to efficiently detect obstacles [Danescu (2011)], pedestrians [Leibe et al. (2005); Lwowski et al. (2017)], etc.

Mapping for autonomous mobile vehicles is a discipline related to computer vision [Fernandez-Madrigal (2012), Thrun et al. (2002) Thrun et al.] and cartography [Leonard et al. (1992) Leonard, Durrant-Whyte, and Cox]. In such environments, one of the preliminary tasks could be the development of a model of the world, using the map of the environment, making use of onboard sensors. The other task would be utilizing the constructed pre-existing map. The map can be developed using SLAM [Fernandez-Madrigal (2012), Dissanayake et al. (2001) Dissanayake, Newman, Clark, Durrant-Whyte, and Csorba]. This usage of the a priori information can be termed as the development of an autonomous vehicle for the known environment. We use this technique of a priori maps developed using RTAB-Map [Labbe, Mathieu et. al.].

Localization. Localization is one of the most fundamental competencies required by an autonomous system, as the knowledge of the vehicle's location is an essential precursor to take any decisions about future actions, whether planned or unplanned. In a typical localization situation, a map of the environment or world is available and the robot is equipped with sensors that sense and observe the environment as well as monitor the robot's motion [Fernandez-Madrigal (2012), Huang and Dissanayake (1999), Huang and Dissanayake (2007), Liu et al. (2007)]. Hence localization is that branch in autonomous system navigation, which deals with the study and application of the ability of a robot to localize itself in a map or plan. In the case of the smart wheelchair, we use the imu details from the Intel Realsense D435i for its initial presence in the operating environment.

Obstacle Avoidance. For successful navigation of an autonomous system, avoiding obstacles while in motion is an absolute requirement [Danescu (2011), Wu and Nevatia (2005), Chavez-Garcia and Aycard (2016), Borenstein and Koren (1988), Ravid and Remeli (2019)]. The vehicles must be able to navigate in their environment safely. Path planning requires one to go in the direction closest to the goal, and generally, the map of the area is already known. On the other hand, obstacle avoidance involves choosing the best direction among multiple non-obstructed directions, in real-time, hence obstacle avoidance can be considered to be more challenging than path planning.

Obstacles can be of two types (i) Immobile Obstacles (ii) Mobile Obstacles. Static object detection deals with localizing objects that are immobile in an environment e.g., of indoor static obstacles can be a table, sofa, bed, planter, TV stand, walls, etc. Outdoor static obstacles can be buildings, trees, parked vehicles, poles (light, communication), (standing or sitting) persons, animals lying down, etc.

Mobile object detection deals with localizing the dynamic objects through different data frames obtained by the sensors to estimate their future state example of indoor moving objects can be walking or running pets at home, moving persons, operating vacuum robots, crawling baby, people moving in wheelchairs, etc. Outdoor moving obstacles can, for instance, be, moving vehicles, pedestrians walking on the pathway, moving ball thrown in the air, flying drone(s), running pets, etc.

The task of obstacle avoidance keeps the vehicle from colliding with obstacles and keeping the vehicle in a safe zone. It is a process that starts with identifying objects that are present in the environment and obstacle avoidance is a critical component of autonomous system navigation [Danescu (2011)]. Autonomous vehicles must be able to navigate their environment safely.

A LiDAR and camera integrated sensing system coupled with a priori maps created using RTAB-Map [Labbe, Mathieu et. al.] with the Intel Realsense D435i were used to implement the obstacle avoidance system. The data collected by the LiDAR and camera were integrated and a model of the mapped details were created and optimized to create a dynamic model of the environment of the wheelchair's operation. This can function in a dynamic manner and can be used in new environments. During tests we found some disadvantages and they are: it is a complex system and might need more complex hardware and the system may not be as accurate as a previous technology we had tested using destination or milestone tags. Extensive obstacle avoidance or mapping is out of scope of this research.

Experiment. The BCI system enables the user to select commands that control, for example, a Jazzy select series wheelchair. The wheelchair has an onboard computer that houses the Linux operating system with Robot Operating System (ROS). The BCI api that communicates with the Cyton hardware, is also present in this computer. ROS contains packages that interface with the api and hence it can accept the ‘commands’ and then execute them, thereby controlling the wheelchair and enabling the user to fulfill a task like reaching a destination. The BCI was developed using the Python programming language with modules like mne, pyriemann, scikitlearn, numpy and other math and string operation modules. The system can be implemented on a Nvidia Tegra TX2. The EEG measurement system is OpenBCI Cyton paired with OpenBCI Wifishield. The entire system can be segregated into the following components: (1) Signal Processing and Command generation—OpenBCI, (2) Command processor—Nvidia Tegra TX2, (3) Command implementation on power wheelchair—e.g., Jazzy pride select wheelchair.

An OpenBCI Cyton board was used to record the signals with the following configuration: 512 sampling rate, 8th order 0.1 to 30.0 Hz passband, and 4th order 58.0 to 62.0 Hz notch Butterworth hardware filters. process and amplify the signal. Test data from 6 able-bodied subjects (20 to 35 years) were collected in the experiment. Confirmation were obtained of adequate sleep of at least 6 hours prior to the study. 2 of them had no previous experience in BCI usage. Participation exclusion was placed on intake of stimulant or depressive substances within the past 24 hours of the study trials, any psychological condition, and sensitivity to light flickering or flashing.

Methodology. Subjects were seated in front of a 10 inch LCD in a comfortable position and were asked to blink as they normally would do and move only if it was absolutely necessary. The distance between the subject eyes and the LCD was approximately between 2 and 3 ft. Detailed introduction to system was given and instructions on how to use the simulation screen and also to count mentally how many times the target flashed. As part of the first experiment, the subjects were instructed to look at the two flickering stimuli of frequencies 8 Hz and 13 Hz on the LED monitor. The LED flicker rate is 60 Hz and so is the electrical frequency and we chose the EEG stimulus flicker so as to function consistently with the 60 Hz frequency. Python programming language is used for coding with ample dependencies on MNE, scikit, PsychoPy and pyRiemann. The hardware to record the EEG signals and amplify them is OpenBCI Cyton+WifiShield. The data needs to be sampled and 256 is sampling rate but this can be updated in the code, along with the number of trials, length of each trail, frequencies and electrode positions. An UltraCortex Mark IV headset with 8 electrodes plus one electrode for reference and one for bias was selected. Dry electrodes were used to limit messing the subjects hair due to the conducting gel. The data was saved in a single CSV file for each experiment for every subject. The one ground electrode was placed on the left ear and the bias was placed on the right ear. The electrodes were O1, Oz, O2, Fp1, Fp2, P3, Pz and P4. The code had a Notch filter of 60 Hz and band pass filter of 7 Hz and 31 Hz, which ensure that the electrical noise impacts a minimum and only signals between 7 and 31 Hz are utilized.

Experiment Steps. (1) Connect subject to the electrodes on EEG Device, (2) Start the device, (3) Wait for stable readings, (4) Perform experiment (Seat subject in a quiet and pleasant environment, Ensure subject makes minimal movement, Relax jaws, eyes, eyebrows and face, Focus on the flickering stimulus, (5) Data analysis preparation (Data load into mne objects, Preprocess the data using Independent Component Analysis and repair as needed, Epoch raw data, detect and analyze the events, Classify using Canonical Correlation Analysis (CCA) and analyze, Decode using filter bank approach—SSVEP ((a) Covariance+Minimum Distance to Mean. This is a very effective Riemannian Geometry classifier, which is simple in implementation), (6) Finalize analysis, (7) Output the finalized selection. For the control command generation, the following is the sample logic. Ideally we choose Robot Operating System to control the assistive mobility vehicle-Jazzy wheelchair [JazzyWheelchair]
1. If frequency between 8.1 and 10.5 (inclusive) go to left side of the lab; For experiment purposes, the wheelchair navigates forward about 7 feet turns left, moves about 3 feet and then turns around facing tangential to the path it originally traversed
2. If frequency between 10.6 and 13.5 (inclusive) go to right side of the lab; For experiment purposes, the wheelchair navigates forward about 3 feet turns left, moves about 3 feet and then turns around facing tangential to the path it originally traversed
3. If frequency between 13.6 and 17.5 (inclusive) stop the wheelchair; The wheelchair will not make a sudden stop but will have a soft stop and will come to a complete halt in 3 seconds, for the safety of the rider.

Mapping. The mapping unit can comprise a IMU based camera whose data is fused with a planar LiDAR lidar scan from RP Lidar A2 model. The lidar was angled to provide a scan of 10 feet in front of the wheelchair. At the time of the experiments, the angle was around 30°. The map generated using the RTabmap is very detailed with the location of the ground, height of the environment, details obstacles such as the distance to them, and their dimensions. The mapping was achieved by using the Realsense D435i series of camera. It should be noted that when the system is initialized, the origin of coordinate frame “odom” is set to the location of the camera at that moment and hence, TF odom→camera_link will always be with respect to that given origin. Whenever RTAB-Map relocalizes itself in the prebuilt map, the tf map→odom will change from an identity transform to the tf from the prebuilt map's origin to the new odom coordinate system.

BCI and control system integration test results. The BCI was integrated with LabStreamingLayer (lsl), which is a streaming/command broadcasting software that enables the broadcasting of the EEG commands, which is consumed by the ROS module. The EEG measurements were classified with an accuracy of 95%. As a test setup, we used 2 signals at 12 Hz and 15 Hz. When the user focused on the 12 Hz flicker, the BCI published the command to the wheelchair, to go to the left side of the lab and the wheelchair navigated to the left portion of the lab. When the user focused on the 15 Hz flicker, the BCI published the command to the wheelchair, to move to the right side of the lab and it navigated to the right of the lab.

Results. Tests were conducted initially to validate if the classifier was able to detect and classify the signals in question, i.e., 8.1 hz, Eyes closed state with 10 hz, 12.1 hz 15.1 hz frequency. We use 10 hz as a basic detection when the subjects close their eyes and relax. The experiments were executed and data was classified using CCA and Riemannian MDM. We find that although both the classifiers performed well, Riemannian MDM classifier outperformed the CCA classifier by 12%. We found the best results around 12 Hz and 15 Hz. The test result details are given below. The MDM classifier was able to classify all the 4 flickers with an accuracy of 90% and MDMF classifier was able to classify all the 4 flickers with an accuracy of 97%. The classifier's efficiency presently is at 10 seconds.

The ICA results. The Progression of the data from Raw to the component analysis should be noted in these plots. ICA enables an easy way to dissect the signal into individual.

The CSD results. Graphs compare 3 types of CSD plots namely: short_fft, multitaper adapter, mortlet wavelet respectively. The CSD graphs clearly point the frequencies in their respective quadrants. These plots provide us a graphical representation of the cross spectral density analysis in the (a) CSD Multitaper (b) CSD Mortet (c) Short FFT. Plots of Implementations of CSD related frequencies. CSD is a useful tool in analyzing spectral density across the various electrodes.

SSVEP plots and validation. MDM is accurate and quite robust in providing results and has exhibited accuracy of over 94%. In the graphs we can clearly see the areas highlighted dependent on the frequency of stimulation i.e., 8, 12 and 15 Hz. Stimulation frequency of 10 hz was observed when subjects closed their eyes and not focusing on any flicked and is highlighted under ‘resting’.

During our hardware implementation, we have observed quick SSVEP signal classifications around 1 to 1.5 seconds, which has proven to be extremely useful in controlling the navigation of the wheelchair. The wheelchair was tested in an extremely constricted space and hence operated at a slow pace of 0.4 meters per second during early tests, but the speed was increased to 0.65 meters per second when the mobility improved. The wheelchair however is capable of operating at around 14 miles per hour and the authors opine that this speed should be restricted only for outdoor usage.

For verification purposes gazebo was used as a simulation environment. The wheelchair navigated as expected in the simulation environment and the output was observed in rviz. This setup was used to test the controller on the wheelchair. It was observed that the lidar scans performed as expected. The wheelchair was able to drive around the cabinets in its way, without running into them. This was improvised in the hardware setup such that a single lidar and an inexpensive stereo camera could be used efficiently for detection and avoidance of obstacles in its path. The images provide a planned path for the wheelchair. These images depict a fusion of the lidar and the stereo camera pointcloud data. The images also provide a planned path for the wheelchair.

Conclusion. An asynchronous SSVEP paradigm has been implemented in a BCI system that commands an autonomous wheelchair for the purpose of navigation in known environments. Previously, Riemannian-MDM classifiers were used to classify EEG signals. Even though conventional classification using CSD or Independent Component Analysis performs well, RMDM outperforms them by a 2 digit percentage factor and moreover the MDM implements complex calculations in a very simple manner with classification accuracy over 91%. RMDM was implemented on the mobility vehicle carrying a mini computational system such as an Intel NUC found that the computation was within expectations wherein the system did not exceed 50% utilization and this is an added advantage of this system when coupled with the ROS navigation system. In addition to RMDM, in future implementations, we will be following a reduction in dimensionality based on suggestions from Congedo et. al. (2011) and Congedo et al. (2017)] and implement a reduced dimension version of RMDM in future research. For now we have implemented the RMDM for cognitive control of an autonomous wheelchair for usage in known environments. As part of future implementations, it is our intention to develop a relatively low cost and in house motor control system that will have the capability to enable a manual-push wheelchair to use powered smart control to assist persons with disabilities.

### IV. Survey of Navigation Techniques with Data Fusion

Autonomous systems can play a vital role in assisting humans in a variety of problem areas. This could potentially be in a wide range of applications like driver-less cars, humanoid robots, assistive systems, domestic systems, military systems, and manipulator systems, to name a few. Presently, the world is at a bleeding edge of technologies that can enable this even in our daily lives. Assistive robotics is a crucial area of autonomous systems that helps persons who require medical, mobility, domestic, physical, and mental assistance. This research area is gaining popularity in applications like autonomous wheelchair systems [Simpson (2005); Fehr et al. (2000)], autonomous walkers [Martins et al. (2012)], lawn movers [Noonan et al. (1993); Bernini (2010)], vacuum cleaners [Ulrich et al. (1997)], intelligent canes [Mutiara et al. (2016)], and surveillance systems in places like assisted living [Bharucha et al. (2009); Cahill et al. (2007); Furness et al. (2000); Topo (2009)]. Data are one of the most important components to optimally start, continue, or complete any task. Often, these data are obtained from the environment that the autonomous system functions in; examples of such data could be the system's position and location coordinates in the environment, the static objects, speed/velocity/acceleration of the system or its peers or any moving object in its vicinity, vehicle heading, air pressure, and so on. Since this is obtained directly from the operational environment, the information is up-to-date and can be accessed through either built-in or connected sensing equipment/devices. This survey is focused on the vehicle navigation of an autonomous vehicle. We review the past and present research using Light Imaging Detection and Ranging (LiDAR) and Imaging systems like a camera, which are laser and vision-based sensors, respectively. The autonomous systems use sensor data for tasks like object detection, obstacle avoidance, mapping, localization, etc. As we will see in the upcoming sections, these two sensors can complement each other and hence are being used extensively for detection in autonomous systems. The LiDAR market alone is expected to reach USD $52.5 Billion by the year 2032, as given in a recent survey by the Yole group, documented by “First Sensors” group. In a typical autonomous system, a perception module inputs the optimal information into the control module. Crowley et al. (1993) define perception. The process of maintaining an internal description of the external environment.

Data Fusion. Data fusion entails combining information to accomplish something. This ‘something’ is usually to sense the state of some aspect of the universe [Steinberg and Bowman (2017)]. The applications of this ‘state sensing’ are versatile, to say the least. Some high level areas are: neurology, biology, sociology, engineering, physics, and so on [McLaughlin (2002); Van Mechelen and Smilde (2010); McGurk and MacDonald (1976); Caputo et al. (2012); Lanckriet et al. (2004); Aerts et al. (2006), Hall and Llinas (1997)]. Due to the very versatile nature of the application of data fusion we will limit our review to the usage of data fusion using LiDAR data and camera data for autonomous navigation. More information about data fusion will be provided in the upcoming sections.

Sensors and Their Input to Perception. A sensor is an electronic device that measures physical aspects of an environment and outputs machine (a digital computer) readable data. They provide a direct perception of the environment they are implemented in. Typically, a suite of sensors is used since it is the inherent property of an individual sensor, in order to provide a single aspect of an environment. This not only enables the completeness of the data, but also improves the accuracy of measuring the environment.

The Merriam-Webster dictionary defines a sensor as A device that responds to a physical stimulus (such as heat, light, sound, pressure, magnetism, or a particular motion) and transmits a resulting impulse (as for measurement or operating a control). The Collins dictionary defines a sensor as an instrument which reacts to certain physical conditions or impressions such as heat or light, and which is used to provide information. Many applications require multiple sensors to be present to achieve a task. This gives rise to the technique of data fusion, wherein the user will need to provide guidelines and rules for the best usage of the data that is given by the sensors. Several researchers have given their definition of data fusion. JDL's definition of data fusion is quoted by Hall et al. (2004) as: A process dealing with the association, correlation, and combination of data and information from single and multiple sources to achieve refined position and identity estimates, and complete and timely assessments of situations and threats, and their significance. The process is characterized by continuous refinements of its estimates and assessments, and the evaluation of the need for additional sources, or modification of the process itself, to achieve improved results. Stating that the JDL definition is too restrictive, Hall et al. (1997); Hall and Linn (1990), Liggins et al. (2009) re-define data fusion as: Data fusion is the process of combining data or information to estimate or predict entity states. Data fusion involves combining data-in the broadest sense-to estimate or predict the state of some aspect of the universe. In addition to the sensors like LiDAR and Camera that are the focus in this survey, any sensor like sonar, stereo vision, monocular vision, radar, LiDAR, etc. can be used in data fusion. Data fusion at this high level will enable tracking moving objects as well, as given in the research conducted by Garcia et al. (2014).

The initial step is raw data capture using the sensors. The data is then filtered and an appropriate fusion technology implemented this is fed into localization and mapping techniques like SLAM; the same data can be used to identify static or moving objects in the environment and this data can be used to classify the objects, wherein classification information is used to finalize information in creating a model of the environment which in turn can be fed into the control algorithm [Chavez-Garcia (2014)]. The classification information could potentially give details of pedestrians, furniture, vehicles, buildings, etc. Such a classification is useful in both pre-mapped i.e., known environments and unknown environments since it increases the potential of the system to explore its environment and navigate.
1. Raw Data sensing: LiDAR is the primary sensor due to its accuracy of detection and also the higher resolution of data and it is effective in providing the shape of the objects in the environment that may contain hazardous obstacles to the vehicle. A stereo vision sensor can provide depth information in addition to the LiDAR. The benefit of using this combination is the accuracy, speed, and resolution of the LiDAR and the quality and richness of data from the stereo vision camera. Together, these two sensors provide an accurate, rich, and fast data set for the object detection layer [De Silva et al. (2018); Rao (1998); Caputo et al. (2012)]. In a recent study in 2019, Ravid et al. went a step further to utilize the raw data and fuse it to realize the benefits early on in the cycle [Ravid and Remeli (2019)]. They fused camera image data with LiDAR pointclouds closest to the raw level of data extraction and its abstraction.
2. Object Detection: Object Detection is the method of locating an object of interest in the sensor output. LiDAR data scan objects differently in their environment than a camera. Hence, the methodology to detect objects in the data from these sensors would be different as well. The research community has used this technique to detect objects in aerial, ground, and underwater environments [Thrun (2002); Ravid and Remeli (2019); Wu and Nevatia (2005); Borenstein and Koren (1988); Felzenszwalb et al. (2009)].
3. Object Classification: The Objects are detected and then they are classified into several types so that they can be grouped into small, medium, and large objects, or hazard levels of nonhazardous or hazardous, such that the right navigation can be handled for the appropriate object. Chavez-Garcia et al. (2016) fuse multiple sensors including camera and LiDAR to classify and track moving objects.
4. Data Fusion: After the classification, the data are fused to finalize information as input to the control layer. The data fusion layer output will provide location information of the objects in the map of the environment, so that the autonomous vehicle can, for instance, avoid the obstacle or stop if the object is a destination or wait for a state to be reached for further action if the object is deemed a marker or milestone. The control segment will take the necessary action, depending on the behavior as sensed by the sensor suite [De Silva et al. (2018); Rao (1998); Qi et al. (2018); Baltzakis et al. (2003); Caputo et al. (2012); Chavez-Garcia and Aycard (2016)].

Multiple Sensors vs. Single Sensor. It is a known fact that most of the autonomous systems require multiple sensors to function optimally. However, why should we use multiple sensors? Individual usage of any sensor could impact the system where they are used, due to the limitations in each of those sensors. Hence, to get acceptable results, one may utilize a suite of different sensors and utilize the benefits of each of them. The diversity offered by the suite of sensors contributes positively to the sensed data perception [Luo et al. (2002); Lahat et al. (2015)]. Another reason could be the system failure risk due to the failure of that single sensor [Shafer et al. (1986); Hall and Llinas (1997), Chavez-Garcia (2014)] and hence one should introduce a level of redundancy. For instance, while executing the obstacle avoidance module, if the camera is the only installed sensor and it fails, it could be catastrophic. However, if it has an additional camera or LiDAR, it can navigate itself to a safe place after successfully avoiding the obstacle, if such logic is built-in for that failure. Roggen et al. (2013), Foo and Ng (2013), and Luo and Su (1999) performed a study on high-level decision data fusion and concluded that using multiple sensors with data fusion is better than individual sensors without data fusion. In addition to the above, several researchers [Lahat et al. (2015); Waltz et al. (1990); Chavez-Garcia (2014); Hackett and Shah (1990); Grossmann (1998)] discovered that every sensor used provides a different type, sometimes unique type of information in the selected environment, which includes the tracked object, avoided object, the autonomous vehicle itself, the world it is being used, and so on and so forth, and the information is provided with differing accuracy and differing details.

There are some disadvantages while using multiple sensors and one of them is that they have additional levels of complexity; however, using an optimal technique for fusing the data can mitigate this challenge efficiently. When data are optimally combined, information from different views of the environment gives an accurate model of the environment the system is being used in.

The second was highlighted by Brooks et al. (1997) who state: A man with one clock knows what time it is. A man with two clocks is never sure! That is, there may be the presence of a level of uncertainty in the functioning, accuracy, and appropriateness of the sensed raw data. Due to these challenges, the system must be able to diagnose accurately when a failure occurs and ensure that the failed component(s) are identified for apt mitigation. At a high level, we can term two types of sensor fusion: Homogeneous data fusion and Heterogeneous data fusion. As the name states, homogeneous data fusion comprises sensor data of the same types of sensors; there may or may not be the same make or model—for example, a stereo vision camera only, GPS data only, or LiDAR data only, etc. On the other hand, heterogeneous data fusion will have varied sensor data. There could be a suite of sensors like GPS, LiDAR, stereo vision camera or GPS and LiDAR or IMU and GPS, etc. In addition, it must be able to tolerate small differences between the same-sensor readings and be able to merge their small discrepancies into a single sensor reading that is reliable. This is done through data fusion, which we will address later. As an example, let us consider humans; redundancy is built into us, which is we have five different senses and among these senses, we have two eyes and two ears, and an entire body of skin that can sense. We use these senses subconsciously, i.e., without specifically instructing our brains to use them appropriately. This should be implemented purposefully, specifically and carefully into an autonomous system. The above-mentioned researchers [Brooks et al. (1997); Shafer et al. (1986)] state that the information obtained by the intelligent system using single sensor will tend to be incomplete and sometimes inaccurate, due to its inherent limitations and uncertainty.

Consider a graphical representation of a simple perception system. The system takes in as input, the sensor data of the perception sensors like LiDAR, sonar, camera, etc., and motion sensors like the odometric, navigational sensors, etc. The output comprises location, distance of the objects in the vicinity, and the current state of the robot to name a few. Although these outputs seem similar, details clearly state that they vary in many ways; for example, a vehicular motion sensor will not provide information about obstacles in front of the robot; a camera cannot provide details about the robot's location like latitude and longitude, etc. (unless a GPS is built into the camera); and therefore a single sensor will not be able to provide all the information that is necessary to optimally perform the complete suite of tasks. Hence, we have the need to use multiple sensors that may be redundant but are complementary and can provide the information to the perception module in the intelligent system. Therefore, the perception module uses information from sensors like LiDAR, camera, sonar, etc. We will detail these sensors and the above-mentioned tasks in the following sections. Combining information from several sensors is a challenging problem [Vu (2009); Vu and Aycard (2009); Lahat et al. (2015)].

Rao et al. (1998) provides metrics comparing the difference(s) between single sensor and multi-sensors. They state that, if the distribution function depicting measurement errors of one sensor is precisely known, an optimal fusion process can be developed, and this fusion process performs similar to if not better than a single sensor. Users can be reassured that the fused data is better than that of a single sensor. Since the sensing layer is better now, the control application can be standardized independently.

Need for Sensor Data Fusion. Some of the limitations of single sensor unit systems are as follows: (1) Deprivation: If a sensor stops functioning, the system where it was incorporated in will have a loss of perception. (2) Uncertainty: Inaccuracies arise when features are missing, due to ambiguities or when all required aspects cannot be measured. (3) Imprecision: The sensor measurements will not be precise and will not be accurate. (4) Limited temporal coverage: There are initialization/setup time to reach a sensor's maximum performance and transmit a measurement, hence limiting the frequency of the maximum measurements. (5) Limited spatial coverage: Normally, an individual sensor will cover only a limited region of the entire environment—for example, a reading from an ambient thermometer on a drone provides an estimation of the temperature near the thermometer and may fail to correctly render the average temperature in the entire environment.

The problems stated above can be mitigated by using a suite of sensors, either homogeneous or heterogeneous [Bosse et al. (1996); Grossmann (1998), Luo et al. (2002); Jeon and Choi (2015); Waltz et al. (1990)] in addition to mitigating the issues of the above data fusion. Some of the advantages of using multiple sensors or a sensor suite are as follows: (1) Extended Spatial Coverage: Multiple sensors can measure across a wider range of space and sense where a single sensor cannot. (2) Extended Temporal Coverage: Time-based coverage increases while using multiple sensors. (3) Improved resolution: A union of multiple independent measurements of the same property, the resolution is better, i.e., more than that of single sensor measurement. (4) Reduced Uncertainty: As a whole, when we consider the entire sensor suite, the uncertainty decreases, since the combined information reduces the set of unambiguous interpretations of the sensed value. (5) Increased robustness against interference: An increase in the dimensionality of the sensor space (measuring using a LiDAR and stereo vision cameras), the system becomes less vulnerable against interference. (6) Increased robustness: The redundancy that is provided due to the multiple sensors provides more robustness, even when there is a partial failure due to one of the sensors being down. (7) Increased reliability: Due to the increased robustness, the system becomes more reliable. (8) Increased confidence: When the same domain or property is measured by multiple sensors, one sensor can confirm the accuracy of other sensors; this can be attributed to re-verification and hence the confidence is better. (9) Reduced complexity: The output of multiple sensor fusion is better; it has lesser uncertainty, is less noisy, and complete.

Levels of Data Fusion Application. Data fusion can be applied at various levels of data gathering or data grouping and are dependent on the abstraction levels of data. We will see in the upcoming sections the abstraction levels of data fusions. The abstraction levels of data fusion are: (1) Decision or High-level data fusion. At the highest level, the system decides the major tasks and takes decisions based on the fusion of information, which is input from the system features [Roggen et al. (2013); Luo and Su (1999)](2) Feature or mid-level data fusion. At the feature level, feature maps containing lines, corners, edges, textures, and lines are integrated and decisions made for tasks like obstacle detection, object recognition, etc. [Chibelushi et al. (1997); Ross and Govindarajan (2005), Ross (2009)](3) Raw-data or low-level data fusion. At this most basic or lowest level, better or improved data are obtained by integrating raw data directly from multiple sensors; such data can be used in tasks. This new combined raw data will contain more information than the individual sensor data. We have summarized the most common data fusion techniques and the benefits of using that technique as well [Mangan (2019)]. The versatility involved in the implementation of data fusion can be realized by the above levels of application.

Data Fusion Techniques. Nature provides us sensing as one of its most important methods for survival in the animal or plant kingdom. In the animal kingdom, this can be seen as a seamless integration of data from various sources, some overlapping and some non-overlapping to output information which is reliable and feature-rich that can be used in fulfilling goals. In nature, this capability is most essential for survival, to hunt for food or to escape from being hunted. As an example in wildlife, consider bears and compare their sensory capabilities; they have a sharp color close-up vision but do not have a good long distant vision. However, their hearing is excellent because they have the capability to hear in all directions. Their sense of smell is extremely good. They use their paws very dexterously to manipulate wide-ranging objects, from picking little blueberries to lifting huge rocks. Often, bears touch objects with their lips, noses, and tongue to feel them. Hence, we can surmise that their sense of touch is very good. Surely they combine signals from the five body senses i.e., sound, sight, smell, taste, and touch with information of the environment they are in, and create and maintain a dynamic model of the world. At the time of need, for instance, when a predator is around, it prepares itself and takes decisions regarding the current and future actions. Over the years, scientists and engineers have applied concepts of such fusion into technical areas and have developed new disciplines and technologies that span over several fields. They have developed systems with multiple sensors and devised mechanisms and techniques to augment the data from all the sensors and get the ‘best’ data as output from this set of sensors, also known as a ‘suite of sensors’. In short, this augmentation or integration of data from multiple sensors can simply be termed as multi-sensor data fusion.

Kanade et al. in the early 1980s used aerial sensor data to obtain passive sensor fusion of stereo vision imagery. Crowley et al. performed fundamental research in the area of data fusion, perception, and world model development that is vital for robot navigation [Crowley (1984); Crowley (1985); Herman and Kanade (1986)]. They realized that data fusion needs to be applied incrementally in their perception problem [Herman and Kanade (1986)]. They developed similar techniques [Crowley (1985)] that used Kanade's incremental approach to build a world model for robot navigation. They generalized fusion work and documented that, using cyclical processes, one can achieve good perception. Brooks developed a visual ad-hoc technique [Brooks (1985)] that was used in robot perception.

Bayesian estimation theory was recommended by Smith et al. for robotic vision [Smith (1987)]. Whyte documented in his research thesis the derivation techniques for optimizing and integrating sensor information, that may be considered as extensions of estimation theory [Durrant-Whyte (1987)]. It was also implemented in a recent study about system noise [Maheswari and Umamaheswari]. Faugeras et al. performed stereo vision calibration using an adaptation of estimation theory as well [Faugeras et al. (1986)].

The community witnessed a growth in the development of techniques that performed the minimization of a required energy function which provided quantitative measurements and constraints and calculates how much the measurements and constraints are violated [Hopfield (1982); Li (1990)]. Further research was performed by Koch et al. (1986) and Poggio and Koch (1985), Blake (1987), and so on, in the areas of implementing neural networks to implement regularization algorithms for the data fusion. Reinforcement learning networks were implemented to implement multisensor data fusion [Ou et al. (2009)].

Symbolic reasoning techniques using artificial intelligence and machine learning contributed to rule-based inference which was studied in OPS5 [Brownston et al. (1985); Forgy (1989)], MYCIN [Shortliffe and Buchanan (1984)], and BBI [Hayes-Roth (1985)]. Any of these inference techniques coupled with constraint-based reasoning techniques.

Over the years, several techniques that have emerged as data fusion paradigms are Zadeh's fuzzy logic [Zadeh et al. (1979)], Duda's symbolic uncertainty management [Duda et al. (1981)], and Shafer's combined evidence techniques that give a basis for inference under uncertainty [Shafer (1976)].

Crowley et al. provide a set of numerical techniques that are represented by a primitive comprising a vector of property estimates and their respective precisions. They showed that Kalman filter prediction equations provide a means for prediction of the model's state [Crowley (1984)].

Waltz et al. (1990) and Llinas and Hall (1992)] define the term multisensor data fusion as a technology concerned with combining data from multiple (and possibly diverse) sensors to make inferences about a physical environment, event, activity, or situation.

The International Society of Information Fusion defines information fusion as “Information Fusion encompasses theory, techniques, and tools conceived and employed for exploiting the synergy in the information acquired from multiple sources (sensor, databases, information gathered by human, etc.) such that the resulting decision or action is in some sense better (qualitatively or quantitatively, in terms of accuracy, robustness, etc.) than would be possible if any of these sources were used individually without such synergy exploitation.” The definition of multi-sensor data fusion by Waltz and Llinas (1990) and Hall (2004) is given as: The technology concerned with the combination of how to combine data from multiple (and possible diverse) sensors to make inferences about a physical event, activity, or Situation The definition, process, and one of the purposes of data fusion is elicited by Elmenreich et al. (2002) as: “Sensor Fusion is the combining of sensory data or data derived from sensory data such that the resulting information is in some sense better than would be possible when these sources were used individually”. With respect to the output data types of the sensors, we can broadly categorize them into homogeneous sensor data and heterogeneous sensor data. Heterogeneous sensor data comprise of different types of sensing equipment, like imaging, laser, auditory, EEG, etc. For example, a monocular camera (RGB) will have pure image data, while a stereo vision camera (RGB-D) could have imaging data for both the cameras and a depth cloud for the depth information, an EEG could output signal details and LiDAR outputs' location details of the object of interest with respect to the LiDAR. Systems with multi-sensor fusion are capable of providing many benefits when compared with single sensor systems. This is because all sensors suffer from some form of limitation, which could lead to the overall malfunction or limited functionality in the control system where it is incorporated.

Garcia et al. in 2017 proposed a novel sensor data fusion methodology in which the augmented environment information is provided to the intelligent vehicles with LiDAR, camera, and GPS. They propose that their methodology leads to safer roads by data fusion techniques in single-lane carriage-ways where casualties are higher than in other road types. They rely on the speed and accuracy of the LiDAR for obstacle detection and camera-based identification techniques and advanced tracking and data association algorithms like Unscented Kalman Filter and Joint Probabilistic Data Association [Garcia et al. (2017)]. Jahromi et al. proposed a real-time hybrid data fusion technique in 2019 [Shahian Jahromi et al. (2019)]. Extended Kalman Filter (EKF) based nonlinear state estimation and encoder-decoder based Fully Convolutional Neural Network (FCNN) are used on a suite of camera, LiDAR, and radar sensors. Data fusion is a vast area with numerous techniques; we provide advantages and disadvantages of data grouping/association, state estimations, and distributed systems [Uhlmann (1994); Rao (1998); Uhlmann (2003); Castanedo et al. (2008)]. The following subsections highlight some of the algorithms used in data fusion.

K-Means. K-Means is a popular algorithm that has been widely employed; Some prominent advantages are: Simpler to implement compared to other techniques. Good generalization to clusters of various shapes and sizes, such as elliptical clusters, circular, etc. Simpler and easy adaption to new examples. Convergence is guaranteed. Scales to large data sets Centroid position can be warm-started. Some prominent disadvantages: Optimal solution for the cluster centers are not always found by the algorithm; The algorithm assumes that the covariance of the dataset is irrelevant or that it has been normalized already. The system must have knowledge of the number of clusters a priori. Assumption is made that this number is optimum.

Probabilistic Data Association (PDA). PDA was proposed by Bar-Shalom and Tse, and it is also known by “modified filter of all neighbors” [Bar-Shalom et al. (2011)]. The functionality is to assign an association probability to each hypothesis from the correct measurement of a destination/target and then process it. Prominent advantages are: Tracking target excellence: Excellent for tracking targets that do not make sudden changes in their navigation PDA is mainly good for tracking targets that do not make abrupt changes in their movement pattern. The prominent disadvantages are [Castanedo (2013); Bar-Shalom et al. (2011)]: Track loss: PDA might display poor performance when the targets are close to each other because it ignores the interference with other targets and hence there is a possibility that it could wrongly classify the closest tracks. Suboptimal Bayesian approximation: PDA gives suboptimal Bayesian approximation when the source of information is uncertain; this might be seen when a LiDAR scans a pole. One target: PDA gives incorrect results in the presence of multiple targets since the false alarm model does not work well. The Poisson distribution typically models the number of false, with an assumption of uniform distribution. Track management: Problems of tracking algorithms must be provided for track initialization and track deletion since PDA needs this a priori.

Joint Probabilistic Data Association. The prominent advantages are as follows [Castanedo (2013); Fortmann et al. (1983); He et al. (2019)]: Robust: JPDA is robust compared to PDA and MHT. Multiple object tracking: The algorithm can be used to track multiple agents (however, with a caveat). Representation of multimodal data: Can represent multimodal state densities, which represent the increase in robustness of the underlying state estimation process The prominent disadvantages of JPDA are as follows [Castanedo (2013); Fortmann et al. (1983); He et al. (2019)]: Computationally expensive: JPDA is a computationally expensive algorithm when employed in multiple target environments since the number of hypotheses' increments exponentially with the number of targets. Exclusive mechanism: It requires an exclusive mechanism for track initialization.

Distributed Multiple Hypothesis Test. The main advantages of MHT-D are [Goeman et al. (2019)]: Very useful in distributed and de-centralized systems. Outperforms JPDA for the lower densities of false positives. Efficient at tracking multiple targets in cluttered environments. Functions also as an estimation and tracking technique The main disadvantage of the MHT-D is as follows [Goeman et al. (2019)]: Exponential computational costs that are in the order of O(nX), where X is the number of variables to be estimated and n is the number of possible associations. Another type of fusion technique is by state estimation.

State Estimation. Also known as tracking techniques, they assist with calculating the moving target's state, when measurements are given [Castanedo (2013)]. These measurements are obtained using the sensors. This is a fairly common technique in data fusion mainly for two reasons: (1) measurements are usually obtained from multiple sensors; and there could be noise in the measurements. Some examples are Kalman Filters, Extended Kalman Filters, Particle Filters, etc. [Olfati-Saber (2007)].

Covariance Consistency Methods. These methods were proposed initially by Uhlmann et al. [Uhlmann (2003); Castanedo (2013)]. This is a distributed technique that maintains covariance estimations and means in a distributed system. They comprise of estimation-fusion techniques. Some prominent advantages are: Efficient in distributed systems; i.e., multimodal multi-sensors as well Fault-tolerant for covariance means and estimates. Some prominent disadvantages are: If the Kalman filter is used for estimation, the exact cross-covariance information must be determined. This could pose a big challenge. Suboptimal results are realized if the iterative application of the technique is used to process a sequence of estimates for a batch application for simultaneous fusion of the estimates.

Decision Fusion Techniques. These techniques can be used when successful target detection occurs [Castanedo (2013); Zhang et al. (2019); Caltagirone et al. (2019)]. They enable high-level inference for such events. Some prominent advantages are: Enables the user to arrive at a single decision from a set of multiple classifiers or decisionmakers. Provides compensatory advantage for other sensors when one sensor is deficient, in a multisensory System. Enables a user to adjust the decision rules to arrive at the optimum. Some prominent disadvantages are: Establishing a priori probabilities is difficult. When a substantial number of events that depend on the multiple hypotheses occur, this will be very complex and a hypothesis must be mutually exclusive. Decision uncertainty is difficult to finalize.

Distributed Data Fusion. As the name suggests, this is a distributed fusion system and is often used in multi-agent systems, multisensor systems, and multimodal systems [Chen et al. (2005); Dwivedi and Dey (2019); Uhlmann (2003)]. Some prominent advantages are: Enables usage across dynamic and distributed systems. Communication costs can be low since systems can communicate with each other after onboard processing at the individual agents/nodes. Some prominent disadvantages are: Spatial and temporal information alignment. Out-of-sequence measurements. Data correlation challenges. Systems may need robust communication systems to share information.

Classifications of Data Fusion Techniques. Classification of data fusion is fuzzy and fluid, in that it is quite tedious and complex to follow and adhere to strict processes and methodologies. Many criteria can be used for the classification of data fusion. Castanedo discussed (2013) the techniques and algorithms for state estimation, data association and finally a higher-level decision fusion. Foo performed a study of high-level data fusion in tactical systems, biomedical systems, information science and security, disaster management, fault detection, and diagnosis [Luo and Su (1999)]. Dasarathy et al. (1997) discuss data fusion methods and several techniques. Luo et al. [Luo et al. (2002)] discuss abstraction levels and Steinberg et al. via JDL [Steinberg and Bowman (2008)] perform basic research in data fusion. The subsections below provide a brief introduction on how we can classify data fusion.

Data Type of Sensor Input and Output Values. Several types of classification emerged out of Dasarathy's input-output data fusion [Dasarathy (1997)]. They can be summarized as follows: Data-in-Data-out (DAI-DAO): Raw data are input and raw data are extracted out. Data-in-Feature-out (DAI-FEO): Raw data are sourced, but the system provides features extracted out of the data as output. Feature-in: Feature-out (FEI-FEO): Features from previous steps of fusion or other processes are fed into the fusion system and better features or higher-level features are output. New and improved features are output as part of this type of fusion. This is also called Feature-fusion [Dasarathy (1997)]. Feature-in: Decision-out (FEI-DEO): The features fed into the input system as the source are processed to provide decisions for tasks and goals as output. This is where simple or high-level features are accepted as input, and processed and decisions are extracted for the system to follow. Most of the present-day fusion is of this type of classification technique. Decision-in-Decision-out (DEI-DEO): Simple and lower-level decisions are accepted by the system and higher-level better decisions are processed out. This is a type of fusion is also called Decision-fusion [Dasarathy (1997)].

Abstraction Levels. In a typical perception system, one comes across the following abstraction of data: pixel, signal, symbols, feature-characteristics [Luo et al. (2002)]. Pixel level classification: is performed on image input from sensors like monocular, stereo vision, or depth cameras, IR cameras, etc. to a system; image processing that is used to improve tasks that look for and extract objects; object features use this technique. Signal level classification: is performed on data involving signals from sensors like LiDAR, sonar, audio, etc. The signal data are directly operated on and output rendered. Symbol level classification: is a technique that employs methods to represent information as symbols. This is similar to the decision-fusion technique of Dasarathy [Dasarathy (1997)] and called decision level. Characteristic level classification: extracts features from signals or images while processing the data and is called feature level.

JDL Levels. Data fusion models divided into five processing layers, interconnected by a data bus to a relationship database [White (1991); Steinberg and Bowman (2008)]. Layer 0: Processes source data comprised of pixel and signal. Information is extracted, processed, reduced, and output to higher layers. Layer 1: Data output from layer 0 is processed here and refined. Typical processes are alignment in the spatial-temporal information, correlation, clustering, association and grouping techniques, false-positive removal and reduction, state estimation, image feature data combination, and state estimations. Classification and identification: state and orientation are the typical outputs. It also performs input data transformation to obtain consistent and robust data-structures. Layer 2: Based on other output of layer 1 or the object refinement layer, analysis of the situation is performed. Based on the data input and the present and past decisions, the situation assessment is performed. A set of high-level inferences is the outcome of this layer. Identification of events and activities are performed. Layer 3: The output of layer 2 i.e., the significant activities and current events are assessed for impact on the system. Prediction of an outcome and threat analysis is performed at this layer. Layer 4: Overall processes from layer 0 through layer 3 are optimized and improved. Resource control and management, task scheduling, and prioritizing are performed to make improvements.

Data Source Relationships. This type of classification uses concepts of data redundancy, data complementing, and data combination [Castanedo (2013)]. Video data overlaps can be called redundant data sources and can be optimized. This is the area of data source classification wherein the same destination or target is identified by multiple data sources. Complementary data sources provide different inputs that can be combined to form a complete target or scene or object—for example, a complete scene if formed using different cameras and the scene can be put together from individual pieces. Combining data sources in a cooperative environment gives a result that is more complex than the input source information.

System Architecture. This type of classification is based on the architecture of the data fusion system. The architecture could be hierarchical, distributed or decentralized, centralized, etc. [Dasarathy (1997); Castanedo (2013); Castanedo et al. (2008)]. This prompts us to think that the researchers classified these systems based on how many agents/nodes are available, how the sensors are spread across these agents/nodes. In a decentralized architecture, all the agents take part in the data fusion task. Each system processes its own and its neighbor's data. The advantages are processing faster since each system could be processing smaller chunks of data. The cons of this process are the high communication costs since several systems need to communicate with each other and the cost is ω(n)2, at each step of communication, and n is the number of nodes. The process is costliest if each node has to communicate with every one of its peers. Contrary to this, in a centralized architecture, a powerful single system will perform the data fusion. Suboptimal systems could end up being resource hogs that take up a lot of resources in the form of bandwidth since raw data are transferred from the sensors to the central processing system. When a higher number of sensors are used, this type of architecture will pose huge resource issues. Moreover, the central unit would need to be very powerful to process and perform data fusion, which could mean an expensive system.

Distributed or decentralized systems: State estimation and data processing are performed locally and then communicated to the other systems. Single node to groups of systems form the range of processing in this architecture. The fusion node processes the result only after the individual data processing at the local level is completed [Chen et al. (2005), Carli et al. (2008); Mahmoud and Khalid (2013)].

Hierarchical systems: A system architecture, wherein the higher-level nodes control the lower level nodes and a mechanism of hierarchical control of data fusion is set up, is the hierarchical data fusion system. In this type of architecture, a combination of distributed decentralized nodes could be employed to achieve data fusion. Back in the second half of the 1990s, Bowman et al. proposed a hierarchical data fusion system [Bowman (1995)] which was reviewed by Hall et al. (1997). Taropa et al. in 2006 proposed a hierarchical data fusion model [Taropa et al. (2006)] in which they use real-time objects in a highly flexible framework and provide these features through an API. Dieterle et al. proposed a data fusion system for object tracking [Dieterle et al. (2017)]. In the publication, they combine sensor information using a hierarchical data fusion approach and show that this approach drastically improves robustness in object detection with respect to sensor failures and occlusions.

Sensor Hardware. We will now briefly introduce some of the hardware that could be used for data fusion in vehicular navigation.

LiDAR. Light Detection and Ranging (LiDAR) is a technology that is used in several autonomous tasks and functions as follows: an area is illuminated by a light source. The light is scattered by the objects in that scene and is detected by a photo-detector. The LiDAR can provide the distance to the object by measuring the time it takes for the light to travel to the object and back. NOAA states: LIDAR, which stands for Light Detection and Ranging, is a remote sensing method that uses light in the form of a pulsed laser to measure ranges (variable distances) to the Earth. These light pulses-combined with other data recorded by the airborne system-generate precise, three-dimensional information about the shape of the Earth and its surface characteristics.

Data Generation in a LiDAR. Different types of data are generated by a LiDAR. Some are highlighted below. (1) Number of Returns: The Light pulses from a LiDAR can penetrate a canopy in a forest. This also means that LiDAR can hit the bare Earth or short vegetation. (2) Digital Elevation Models: Digital Elevation Models (DEM) are earth (topographic) models of the Earth's surface. A DEM can be built by using only ground returns. This is different from Digital Terrain Models (DTM), wherein contours are incorporated. (3) Digital Surface Models: A Digital Surface Model (DSM) incorporates elevations from manmade and natural surfaces. For example, the addition of elevation from buildings, tree canopies, vehicular traffic, powerlines, vineyards, and other features. (4) Canopy Height Model: Canopy Height Models (CHM) provides the true height of topographic features on the ground. This is also called a Normalized Digital Surface Model (nDSM). (5) Light Intensity: Reflectivity or Light intensity varies with the composition of the object reflecting the LiDAR's return. Light intensity is defined as the reflective percentages.

Classifying the LiDAR. LiDAR can be generally classified based on the data returned, technology used, area of usage. Data Returned by the LiDAR: LiDAR types based on storing the data returned from the object [Kim et al. (2019)]: (1) Discrete LiDAR: While scanning, the data returned are in the form of 1st, 2nd, and 3^{rd} returns, due to the light hitting multiple surfaces. Finally, a large-final pulse is returned. This can be seen when a LiDAR hits a forest canopy [Miltiadou et al. (2019)]. When the LiDAR stores the return data individually/discretely, it takes each peak and separates each return. (2) Continuous/Full waveform LiDAR: When the entire waveform is saved as one unit, its a continuous or full form LiDAR [Hu et al. (2020)]. A lot of LiDARs use this form of recording.
Lidar types based on technology: The following technology types can be considered as well while classifying LiDARs [Warren (2019)](1) Mechanical-scanners: Macro-scanners, Risley prisms, Micro-motion. (2) Non-Mechanical-scanners: MEMS, Optical phased arrays, electro-optical, liquid crystal. (3) Flash-LiDAR-non-scanners. (4) Structured light-non-scanners.

### (5) Multicamera-Stereo-Non-Scanners

Based on area of usage: Two types of LiDAR broadly used are: topographic and bathymetric. Topographic LiDARs are typically used in land mapping, and they use near-infrared laser and bathymetric LiDARs use green light technology for water-penetration to measure river bed elevations and seafloor.

In Topographic LiDAR, the two main types are 2D (single scan) and 3D (multiple scan). Some brands of topographic LiDAR are Velodyne, another model from Velodyne, the HDL-64E provides a 3D laser scan i.e., 360° horizontal and 26.9° vertical field of view (FOV), while 2D LiDARs like the TiM571 LiDAR scanning range finder from SICK provide a 2D 220° FOV this is very similar to RPLidar from Slamtech, Ouster from Ouster laser scanners, Eclipse mapping systems. The Bathymetric LiDARs use the green spectrum technology and are predominantly used for water surface and underwater mapping tasks. A small listing and background of Bathymetric LiDARs are given by Quadros et al. (2013). However, bathymetric LiDARs are out of the scope of this survey due to its nature of use.

Advantages and Disadvantages in Using LiDAR. LiDARs are very useful in detecting objects and developing an environment model [Caltagirone et al. (2019)]. It does have both usage advantages and disadvantages. Advantages include Safety in usage, fast scans of the environment, high accuracy, and some can capture data even at 2500 m and have better resolution compared to other scan systems like Radar.

Disadvantages include: Many products are still very expensive, data are not as rich as an RGB camera with a good resolution, a single data point may not be accurate and high volume data points will need to be used, their scans and eventual point clouds are too big and consume a lot of space, and 2D LiDARs are useful mainly as line scanners and hence are sparingly used.

Camera. The types of camera are Conventional color cameras like USB/web camera; RGB, RGB-mono, and RGB cameras with depth information; RGB-Depth (RGB-D), 360° camera, and Time-of-Flight (TOF) camera.

RGB Family of Camera. An RGB camera is typically a camera equipped with a standard CMOS sensor through which the colored images of the world are acquired. The acquisition of static photos is usually expressed in megapixels. Advantages and disadvantages of RGB cameras are as follows: Advantages include availability of several inexpensive cameras, and they do not need any specialized drivers, simplicity in usage, etc. The disadvantages include that the presence of good lighting is essential, some of the high-end cameras that have great resolution are very expensive, and there are RGB-D cameras that cannot efficiently capture surfaces that are reflective, absorptive, and transparent such as glass and plastic.

360° Camera. A 360° camera captures dual images or video files from dual lenses with 180° field of view and either performs an on-camera automatic stitch of the images/video or lets the user perform off-board stitching of the images, to give a full 360° view of the world [Sigel et al. (2003); De Silva et al. (2018)].

Some advantages and disadvantages are as follows: Advantages include new technology possibilities in usage and improvements being higher, and hardware or software may be used to get 360 images, etc. Disadvantages include diminished quality, few cameras are expensive, long rendering time, storage may be needed more in high-resolution cameras, etc.

Time-of-Flight (TOF). The TOF gives depth information based on IR and camera technology. It works by emitting an infrared light signal and measures how long the signal takes to return and calculates the depth based on extracted data. This information can be used with several navigation-related modules like mapping and obstacle avoidance [MyllylAC et al. (1998); Nair et al. (2012); Hewitt and Marshall (2015)].

Some advantages and disadvantages are highlighted in Turnkey as follows: Advantages include high speed, efficient usage of computation since TOF uses a one look approach compared to the multiple scans of laser scanners, long working distance, depth information up to 5 m given in real-time, wide application range (feature-filled or featureless, depth information given by camera in the presence or absence of ambient light).

Disadvantages include low resolution, relatively high power consumption due to which high heat may be generated, affected by object's reflective, color and complexity of the environment, may need additional management of subjects' background lighting, multiple path reflections, usage of multiple TOF at the same time may have interference with each other, supported application scenarios are less, and development and support groups are low in number.

In some autonomous vehicles, radar is used in addition to camera [Hinkel and Knieriemen (1989)].

Implementation of Data Fusion with the Given Hardware. We review an input-output type of the fusion as described by Dasarathy et al. (1997). They propose a classification strategy based on input-output of entities like data, architecture, features, and decisions. The fusion of raw data in the first layer, a fusion of features in the second, and finally the decision layer fusion. In the case of the LiDAR and camera data fusion, two distinct steps effectively integrate/fuse the data [John Campbell (2018), De Silva et al. (2018)]: (1) Geometric alignment of the sensor data.

### (2) Resolution Match Between the Sensor Data.

Geometric Alignment of the Sensor Data. The first and foremost step in the data fusion methodology is the alignment of the sensor data. In this step, the logic finds LiDAR data points for each of the pixel data points from the optical image. This ensures the geometric alignment of the two sensors [De Silva et al. (2018)].

Resolution Match between the Sensor Data. Once the data is geometrically aligned, there must be a match in the resolution between the sensor data of the two sensors. The optical camera has the highest resolution of 1920×1080 at 30 fps, followed by the depth camera output that has a resolution of 1280×720 pixels at 90 fps and finally the LiDAR data have the lowest resolution. This step performs an extrinsic calibration of the data. Madden et al. performed a sensor alignment [Maddern and Newman (2016)] of a LiDAR and 3D depth camera using a probabilistic approach. De Silva et al. (2018) performed a resolution match by finding a distance value for the image pixels for which there is no distance value. They solve this as a missing value prediction problem, which is based on regression. They formulate the missing data values using the relationship between the measured data point values by using a multi-modal technique called Gaussian Process Regression (GPR), developed by Lahat et al. (2015). The resolution matching of two different sensors can be performed through extrinsic sensor calibration. Considering the depth information of a liDAR and the stereo vision camera, 3D depth boards can be developed out of simple 2D images.

For a stereo vision or depth camera like the Intel Realsense d435, there is a need to perform a depth scale calibration. Another addition to the calibration toolkit is the speck pattern board. These pattern boards in (not to scale). It has been documented that a passive target or LED-based projector gives about 25-30% better depth accuracy than a laser-based projector. After using adequate turning mechanisms, the depth accuracy can be improved even more. The projector can be a drawback in some cases, and it may help to turn off the projection from the camera and light up the subject using clean white light. It is also observed that the RealSense cameras have better performance in open bright sunlight since there is better visibility of the natural textures. It should be noted that, in the case of the depth cameras, the stereo vision has a limitation due to the quality differences between the left and right images.

There are several calibration techniques for the LiDAR and camera, wherein Mirzaei et al. (2012) have provided techniques for intrinsic calibration of a LiDAR and extrinsic calibration based on camera readings.

Dong et al. (2018) has provided a technique for extrinsic calibration of a 2D LiDAR and camera. Li et al. (2015) also have developed a technique for 2D LiDAR and camera calibration-however for an indoor environment. Kaess et al. (2018) developed a novel technique to calibrate a 3D LiDAR and camera.

Challenges with Sensor Data Fusion. Several challenges have been observed while implementing multisensor data fusion. Some of them could be data related to like: complexity in data, conflicting and/or contradicting data, or they can be technical such as resolution differences between the sensors, the difference in alignment between the sensors [De Silva et al. (2018)], etc. We review two of the fundamental challenges surrounding sensor data fusion, which are the resolution differences in the heterogeneous sensors and understanding and utilizing the heterogeneous sensor data streams [De Silva et al. (2018)] while accounting for many uncertainties in the sensor data sources [Lahat et al. (2015)]. We focus on reviewing the utilization of the fused information in the autonomous navigation, which is challenging since many autonomous systems work in complex environments, be it at home or work, which is to assist persons with severe motor disabilities to handle their navigational requirements and hence pose significant challenges for decision-making due to the safety, efficiency, and accuracy requirements. For reliable operation, decisions on the system need to be made by considering the entire set of multi-modal sensor data they acquire, keeping in mind a complete solution. In addition to this, the decisions need to be made considering the uncertainties associated with both the data acquisition methods and the implemented pre-processing algorithms. Our focus in this review is to survey the data fusion techniques that consider the uncertainty in the fusion algorithm.

Some researchers used mathematical and/or statistical techniques for data fusion. Others used techniques comprised of reinforcement learning in implementing multisensor data fusion [Ou et al. (2009)], where they encountered conflicting data. In this study, they fitted smart mobile systems with sensors that enabled the systems to be sensitive to the environment(s) they were active in. The challenge they try to solve is mapping the multiple streams of raw sensory data Smart agents to their tasks. In their environment, the tasks were different and conflicting, which complicated the problem. This resulted in their system learning to translate the multiple inputs to the appropriate tasks or sequence of system actions.

Brooks et al. (1997) achieve sensor data robustness, reliability, and resolve issues like mechanical failures, noise, transient errors using multiple sensors, whose data is fused. They recommend fusing readings from multiple heterogeneous sensors. This made their overall system less sensitive to failures from one technology. Crowel et al. developed mathematical tools to counter uncertainties with fusion and perception [Crowley and Ramparany (1987)]. Other implementations include adaptive learning techniques [Jing et al. (2017)], wherein the authors use D-CNN techniques in a multisensor environment for fault diagnostics in planetary gearboxes.

The other challenges are dependent on the sensor itself, i.e., the hardware, or the physics that are used by the hardware. Structural errors in the hardware are an example. These errors are the difference(s) between a sensor's expected value and measured value, whenever the sensor is used for data collection. Repeated differences can be calculated using a technique called sensor calibration. Before using any sensor, it needs to be calibrated. This will ensure a consistent measurement, i.e., where all the sensors can be fused uniformly.

Broadly, one can differentiate calibration into extrinsic and intrinsic. Extrinsic calibration entails finding external parameters that are used in the sensors—for example, parameter differences between a LiDAR's alignment/orientation and a camera's alignment/orientation [Guindel et al. (2017); Dong and Isler (2018)]. In another case, it may be the LiDAR's orientation and location in its working environment or world. In contrast, intrinsic calibration entails finding the differences within the same sensor. For example, relationship(s) between the camera coordinates and its pixel coordinates. Usually, the manufacturer performs intrinsic calibration and communicates the details to the end-user in the user guide/manual.

Researchers have found that extrinsic calibration can be challenging when the number of agents is high as in cases of swarms of robots [Mirzaei et al. (2012); Zhou et al. (2018); Dong and Isler (2018)]. For example, senior living where the swarms of autonomous wheelchairs work together to share information about location, situation awareness, etc.; this could be attributed to the variations that exist between sensors due to manufacturing differences, types of sensors, and autonomous system types. In such an example, the calibration duration will be large if there is a large number of autonomous systems; in fact, it could be exponential and hence exorbitant and unacceptable. Reducing both the time required for the process and the complexity is essential.

Sensor Data Noise. Every sensor has an amount of noise that is inherent to its properties. There have been many attempts at reducing or removing the noise—for instance, in object detection [Nobrega et al. (2007)] wherein the authors provide a method and technique to remove noise in LiDAR intensity images. They use a type of diffusion filtering called anisotropic filtering to retain the scanned object space details and characteristics. The second research is where the background noise is removed [Cao et al. (2013)], wherein the authors develop a methodology to identify background noise under the clear atmospheric condition and derive equations to calculate the noise levels. Topics other than object detection are speech recognition [Hansler and Schmidt (2006); Gannot et al. (1998)]. In this section, we discuss filtering noise using the Kalman Filter. Kalman filter is over five decades old and is one of the most sought after filtering techniques. We will discuss two flavors of Kalman filter, namely: Extended Kalman Filter and Unscented Kalman Filter.

In addition to the sensing information, every sensor is bound to have a level of noise and, while using these sensors, one will soon realize that at least a small amount of noise is bound to exist in addition to measurement and estimation of uncertainties. When such errors or uncertainties occur, it is required to use techniques that mitigate their effects on the system. This now becomes a complex problem of estimating the state(s) of the system after the system becomes observable. Mathematical algorithms that accomplish this are the filtering techniques. Filtering techniques are applicable in several domains like economics, science, and engineering. Localization systems can make use of these techniques as there is an innate level of sensor measurement noise and uncertainty with their pose estimation. Filtering techniques have been used in many localization systems and two of the most popular filtering algorithms are Kalman filters and particle filters.

Kalman Filters. Kalman filters (KF) were introduced by Rudolf Kalman in 1960 [Kalman et al. (1960)]. It is also known as Linear Quadratic Estimation (LQE) in the field of controls and autonomous systems. KF is versatile and has been extensively used in the areas of autonomous systems, signal processing, system navigation, defense, aerospace, etc., and it is an iterative algorithm that uses Bayesian inference to estimate the probabilistic distribution of the uncertain/unknown variables. They use a series of measurements that have noise from measurements and process(es). This is because unknown variables can be estimated better with multiple measurements than with a single measurement. The algorithm is optimized to run in real-time and needs only the previous system state and the current input measurement. The KF starts with the system model and the known control inputs to that system, and multiple sequential measurements (measurements from sensors) and forms an estimate of the system's varying quantities (provided in the state matrices). Incidentally, it is found to be better than the estimate obtained using a single measurement. Kalman Filter can also be broadly categorized as a common sensor fusion and data fusion algorithm.

A Dynamic System Model can be represented as follows:

$${x}_{k} = {Ax}_{k - 1} + {Bu}_{k} + {w}_{k - 1} \qquad ( 5.1 )$$

$${z}_{k} = {Hx}_{k} + {v}_{k} \qquad ( 5.2 )$$

where: xk: Current estimate, xk-1: Estimate of the signal in Previous state, uk: Control signal, zk: Measured value from the sensors, wk-1: Process noise in the previous iteration, vk: Measurement noise in the present iteration.

Equations (5.1) and (5.2) are a simple system model where k denotes the current time sample. Equation (5.1) denotes the current estimate of a state variable xk, which is comprised of the previous system state xk-1, the control signal uk, and the process noise in the previous iteration wk-1. Equation (5.2) calculates the current measurement value zk, which is a linear combination of the unknown variable and the measurement noise vk and this is usually a Gaussian. A, B, and H are matrices that provide the weights of the corresponding component of the equation. These values can be provided a priori and are system dependent. A Gaussian distribution with a zero mean contributes two noise values, namely wk-1 and vk; these have covariance matrices named Q and R, respectively, and they are estimated a priori, although they initially provide a coarse estimate; over the set of iterations, the algorithm does converge to the accurate estimators.

There are two steps that dominate the process and they are: the time update and the measurement update; in turn, each step has a set of equations that must be solved to calculate the present state. The following is the algorithm:
1. Predict state

$${\hat{x}}_{k}^{-} A {\hat{x}}_{k - 1} + {Bu}_{k} \qquad ( 5.3 )$$

$${𝒫}_{k}^{-} = A \cdot {𝒫}_{k - 1} {A}^{T} + Q \qquad ( 5.4 )$$

2. Measurement Update-Calculate the Kalman gain (weights)

$${K}_{k} = {𝒫}_{k}^{-} {{H}^{T} [ H {𝒫}_{k}^{-} {H}^{T} + ℛ ]}^{- 1} \qquad ( 5.5 )$$

Kk: Kalman gain—The main and unknown value in this equation
3. Update state

$${\hat{x}}_{k} = {\hat{x}}_{k}^{-} + {K}_{k} ( {z}_{k} - H {\hat{x}}_{k}^{-} ) \qquad ( 5.6 )$$

4. Update state covariance

$${𝒫}_{k} = [ ℐ - {K}_{k} H ] {𝒫}_{k}^{-} \qquad ( 5.7 )$$

5. Loop (now k becomes k+1), which is the next and subsequent iterations, where: Pk—: Prior error covariance Matrix, P: Current Covariance Matrix, updated during each iteration, Q: Covariance Matrix, R: Measurement Noise Covariance Matrix.

This filter's output is the result of the state update and state-covariance update equations. These provide the combined estimate from the prediction model and measurements from sensors. The mean value of the distribution for each state variable is provided by state matrix and the variances by the covariance matrix. A set of measurements are taken in the present state. The system initializes many matrices. The state variables x0,0 can be set based on the initial measurements from the sensors. The covariance of the state can be initialized using the identity matrix I or the covariance matrix Q. Initially, the covariance matrix is not stable but will stabilize as time progresses and the system runs.

Measurement noise covariance R matrix is calculated using calibrations performed earlier. The measurement sensors will be developed to measure a large number of readings of the ground truth state, from which the variances can be calculated. The variance of the measurements provides the value of σ2n in R.

Using literal interpretation(s) from state transition, equations can be used to place the much-needed bounds on dynamic noise. This is because it will be harder to calculate the dynamic noise covariance Q. For instance, 3 sigma in σ2 a in Q can be calculated by interpreting the target acceleration as a constant velocity model with dynamic noise.

The relative ratio of the measurement noise to the dynamic noise is an important factor. This helps calculate the gains. In the Kalman Filter, it is known to keep one of the noise covariance matrices constant while adjusting the other continuously until the desired performance is achieved. The family of Kalman Filters is to be used in systems that can be run continuously for better accuracy or performance and cannot be used for quick/few iterations since it takes several iterations just to stabilize while using Kalman Filters.

The Kalman filter can become very inefficient and the convergence to the required values can take several steps; to reduce this, i.e., for the system to convergence in fewer steps, the system must be modeled more elegantly and precise estimation of the noise must be achieved.

Extended Kalman Filter. The world functions mostly in a nonlinear manner. Hence, if the techniques used to measure, estimate, predict, analyze, etc. are nonlinear, it is practical, convenient, or accurate. This applies to Kalman Filter as well. The nonlinear filtering problem heuristic is the Extended Kalman Filter (EKF). This technique is naturally the most sought after filtering and estimation for nonlinear systems.

The EKF is based on linearizing dynamics and output functions at an existing estimate(s). In an EKF, the state distribution is usually approximated by a Gaussian Random Variable (GRV), which is then analytically propagated through a first-order linearization of the given nonlinear system under consideration [Gelb (1974), Julier and Uhlmann (1996), Norgaard et al. (2000); NoRgaard et al. (2000)]. For example, it functions by propagating an approximation of the conditional expectation and covariance [Lefebvre* et al. (2004); NoRgaard et al. (2000); Gelb (1974); Julier and Uhlmann (1996); Julier et al. (2000); Sorenson (1985)].

Unscented Kalman Filters. Unscented Kalman Filters (UKF) belong to the class of filters called Linear Regression Kalman Filters. These filters are also called Sigma-Point Kalman Filters [Julier and Uhlmann (1997); Julier and Uhlmann (2004)]. This type of filter linearizes a nonlinear function of a random variable using a linear regression algorithm between n points drawn from the previous distribution of the given random variable. This is also called statistical linearization.

We have seen that the EKF propagates the state distribution through the first order linearization; this may corrupt the posterior mean and covariance. The flaws of EKF have been highlighted by Wan et al. [Wan and Van Der Merwe (2000)]. The UKF is robust to this issue since its derivative free and uses a deterministic sampling [Julier (2003)]. This logic chooses a set of points called sigma points to represent the state distribution. UKF has an additional step in the selection of sigma points. Broadly, the following are the steps involved: Select sigma points; Model forecasting; Data assimilation.

When data in the input system is symmetric, a deterministic sampling of the data points can approximate the probability density in which the underlying distribution is Gaussian. The nonlinear transformation of the points is an estimation of the posterior distribution. Julier and Uhlmann [Julier and Uhlmann state that Unscented transformation is “Founded on the intuition that it is easier to approximate a probability distribution than it is to approximate an arbitrary nonlinear function or transformation” ].

Distributed Kalman Filter. Over the past decade, a new technique of filtering that can be used in distributed and dynamic systems has been proposed by Olfati-Saber (2005) and (2007)]. Techniques of consensus are used to fuse and filter the sensor data and apply covariance information to sensor networks with varying observation matrices. They prove that this provides a collective observer for the processes in the environment that the model uses. They propose a continuous-time distributed Kalman Filter (DKF) that performs a local mean of the sensor data but reaches a consensus with other agents/nodes in the selected network. The above authors also proposed a micro Kalman filter technique wherein an embedded low pass and bandpass consensus filter was used. The consensus filters performed a fusion of the sensor data and co-variance data measured at each agent/node.

Broadly, there are two types of the DKF from the above author: Consensus on Estimates (1) Local Kalman filtering, (2) Continuous-time Distributed Kalman filtering, (3) Iterative Kalman-Consensus filtering

Consensus on sensor data fusion. Carli et al. proposed a distributed Kalman Filter based on consensus strategies [Carli et al. (2008)], wherein they estimate the state of a dynamic system from distributed noisy measurements. Every agent/node constructs a local estimate based on its individual measurements and also estimates from its neighbors (connected agents). They perform this over a two-step process: the first one being a Kalman based measurement update and the second one being an estimate fusion that uses a consensus matrix. They document that optimizing the consensus matrix for fast convergence.

Spanos et al. proposed a DKF techniques in their research [Spanos et al. (2005)] in 2005. The performance of an approximate DKF is analyzed in this research. This technique admits systematic analysis of quantities of several networks like connection density, bandwidth, and topology. The contribution is a frequency domain characterization of the steady-state performance of the applicable DKF. They demonstrate a simple error transfer function with a bound while incorporating the connection density, network topology, and communication bandwidth that performs better using their approach.

Mahmoud et al. performed a review of the DKF during 2013 [Mahmoud and Khalid (2013)], wherein they compared a centralized Kalman Filter with a distributed Kalman Filter and bring out DKF's advantages, its techniques, challenges involved, and applications.

Julier et al. wrote a handbook highlighting decentralized data fusion (DDF) with co-variance intersection. This follows a distributed framework in the area of control and estimation. The DDF provides increased robustness and scalability as compared to centralized versions. They state that the time required to implement new computational and sensing components is reduced using DDF.

Recent studies have been performed including optimization of several factors. Some include DKF with finite-time max consensus, DKF over networks with random link failures, etc. These studies suggest that the techniques of DKF are vital in the field of autonomous systems to optimize the system, reduce noise and optimal estimation, etc.

Particle Filters. Particle filters were first introduced in 1993 [Gordon et al. (1993)], and have continuously become a very popular class of numerical methods for optimizing the solution of nonlinear non-Gaussian scenarios [Thrun (2002), Doucet (2001)]. While Kalman filters are linear quadratic estimators (LQE), particle filters, like any member of the family of Bayes filters such as Kalman filters and Hidden Markov Model (HMMs), estimate the posterior distribution of the state of the dynamical system conditioned on the data:

$$π ( {x}_{1 : n} ) = \frac{{γ}_{n} ( {x}_{1 : n} )}{{Z}_{n}} \qquad ( 5.8 )$$

where π(x1:n) is a sequence of target probability densities with increasing dimension, in which every distribution π(x1:n) is defined through the space χn.

We need to know only: γn: χn−→R+. Zn, which is a normalizing constant is given by:

$${Z}_{n} = \int {γ}_{n} ( {x}_{1 : n} ) {dx}_{1 : n} \qquad ( 5.9 )$$

Note that Zn may be unknown. The particle filter provides an approximation of π(x1) and an estimate of Z1 at time 1. Then, an approximation of π2 (x1:2) is also an estimate of Z2 at time 2. Considering the simplest implementation wherein γn(x1:n)=p(x1:n, y1:n), we find that it yields πn(x1:n)=p(x1:n|y1:n) and Zn=p(y1:n)

Broadly, there are three steps involved in implementing a particle filter [Bugallo et al. (2007); Van Der Merwe et al. (2001)]. They are: (1) Importance sampling: Sample the present trajectories and update, Normalize the weights. (2) Selection: Samples that have high importance weights are multiplied, Samples that have low importance weights are suppressed. (3) Markov Chain Monte Carlo Transition: Apply Markov transition kernel with an invariant distribution that is given by p(x0:t(i)|y1:t) and obtain (x(i)0:t)

In comparison with standard approximation methods, such as the popular Extended Kalman Filter, the principal advantage of particle methods is that they do not rely on any local linearization techniques or any crude functional approximation [Carpenter et al. (1999); Van Der Merwe et al. (2001)]. They can be used in areas like large systems, where Kalman Filters tend to fail [Hsiao et al. (2005)]. This technique, however, has its drawbacks, which are expensive computational processes and complexity. Back in 1993, this was an issue, but, nowadays, we can make use of CPU, GPU, and similar high power computing to reduce the computational effort. One of the main deficiencies in a particle filter is that: Particle filters are insensitive to costs that might arise from the approximate nature of the particle representation. The other is that, in uninformative sensor readings, samples tend to congregate and a process that times how long it takes for the samples to congregate is essential.

Autonomous Navigation Robot navigation has been extensively studied in the community for several decades [Waxman et al. (1985); Delahoche et al. (1997); Zingaretti and Carbonaro (1998); Thrun (2002), Thorpe et al. (1988), Zimmer (1996)]. It can be termed as the safe mobility of the robot from a source location to a target location, without hurting people or properties in its environment, and without damaging itself, and these tasks are performed with no or limited need for a human operator. This means that the navigation system is also responsible for decision-making capability when the system faces situations (critical or otherwise) that demand negotiation with humans and/or other robots. Autonomous navigation is a task that takes in the output from a sensor data fusion module. The Kenneth Research Group performed a detailed study about the future of Autonomous Navigation and state.

Autonomous navigation means that a vehicle can plan its path and execute its plan without human intervention. An autonomous robot is one that not only can maintain its stability as it moves, but also can plan its movements. They use navigation aids when possible, but can also rely on visual, auditory, and olfactory cues. The Global Autonomous Navigation Market was valued at USD $2.52 Billion in 2019, and it is further estimated to grow at a CAGR of 16.2% from 2019 to reach USD $6.15 Billion by the year 2025. The Asia Pacific Autonomous Navigation Market is excepted to develop at the most elevated CAGR during the forecasted period 2019-2025.

Research group BIS performed an analysis on the Global Vision and Navigation System Market for Autonomous Vehicle: They focused on Components (Camera, LiDAR, Radar, Ultrasonic Sensor, GPS, and IMU), Level of Autonomy, and Region and quotes: The automotive industry is on the verge of a revolution with the gradual development of self-driven vehicles. The global vision and navigation system industry for autonomous vehicle depicts the market that is expected to witness a CAGR of 26.78%, during the forecast period from 2019 to 2024.

Autonomous navigation is a formidable task that entails steering the vehicle, registering obstacles all around the vehicle, focusing on the speed at which the vehicle travels, ensuring the destination is reached before the fuel is exhausted, and so on. Other autonomous mobile systems usually have similar tasks but of varying magnitudes. This review focuses on using sensing technology for the three main tasks that are typically part of autonomous navigation. These tasks are Mapping, Localization, and Obstacle avoidance. We will review these tasks in greater detail. The three tasks can also be interpreted as the following process(es).

The availability of new-age sensors, advanced computing hardware, and algorithms for processing and fusion of data have made an extremely complex task of information fusion relatively easier to accomplish. This is because, in the past, due to limited computing capabilities, lower sensing quality of then available sensors or exorbitant cost of adequate computing or high-quality sensors, researchers like Brooks (1986) chose to develop and use technologies like subsumption architecture that could be implemented on small computers without the use of its memory or storage. Decision-making relies on data fusion which comprises combining inputs from various sources to get a more accurate combined sensor data as output [Chavez-Garcia and Aycard (2016), Luo et al. (2002); Jeon and Choi (2015); Waltz et al.c (1990)]. Each sub-system is detailed below.

Mapping. The task of mapping senses the environment that the robot operates in and provides data to analyze it for optimal functioning. It is also a process of establishing a spatial relationship among stationary objects in an environment. Efficient mapping is a crucial process that gives rise to accurate localization and driving decision making. Usage of LiDARs for mapping is beneficial as they are well known for their high-speed and long-range sensing and hence long-range mapping, while cameras RGB, and RGB-Depth are used for short-range mapping and also used to efficiently detect obstacles [Danescu (2011)], pedestrians [Leibe et al. (2005); Lwowski et al. (2017)], etc. There are various mapping techniques of which topological, metric, and hybrid are more useful than others and hence highlighted in this survey.

Topological Mapping. Topological mapping is usually represented as graphs and is based on connectivity, the environmental structure, and dense surface information [Kortenkamp and Weymouth (1994)]. The positional information in these maps do not correlate to the real world; they are mere representations of their existence. Topological approaches [Engelson and McDermott (1992), Kortenkamp and Weymouth (1994), Kuipers and Byun (1991)] represent robot environments as graphs. The nodes represent situations, areas, or objects (landmarks) (such as doorways, windows, and signboards). The nodes are interconnected by arcs if the two nodes have a direct path between them. Both these robot mappings have demonstrated orthogonal strengths and weaknesses. Occupancy grids are easy to construct and maintain in large-scale environments [Thrun and Bucken (1996), Thrun et al. (1996)] and establish different areas based on the robot's geometric position within a global coordinate frame. The position of the robot is incrementally estimated using the odometric information and sensor readings taken by itself. Thus, the number of sensors readings that are unbounded are utilized here to determine the robot's location. Topological approaches determine the position of the robot relative to the model primarily based on the environment's landmarks or distinct, the temporal sensor features [Thrun and Bucken (1996)]. For example, if the robot traverses two places that seem identical, topological approaches often have difficulty determining if these places are the same or not especially if they have been approached through different paths. In addition, since sensory input usually depends strongly on the robot's viewpoint, if its sensory input is ambiguous, topological approaches may fail to recognize geometrically nearby places even in static environments, making it difficult to construct large-scale maps. This limitation is reduced in topological approached by their compactness. The resolution of topological maps corresponds directly to the complexity of the environment. The compactness of topological representations gives them three key advantages over other approaches: (i) fast planning, (ii) interfacing to symbolic planners and problem-solvers, and (iii) natural interfaces for a human speech like instructions (such as “go-to kitchen”). They recover early from slippage and drift since they do not require the exact determination of the geometric position of the robot which must be constantly be monitored and compensated as in a grid-based approach.

Grid Based Approach. Grid-based approaches [Moravec (1988), Elfes (1989), Borenstein and Koren (1991)] represent the robot environments as evenly-spaced grids. Each grid cell may contain a representation of an obstacle or a free path to the target as applicable. Grid-based approaches are hampered by their enormous space and time complexity. This is because the resolution of a grid must be fine enough to capture the details of the robot world [Ramsdale et al. (2017)]. Jiang et al. developed a method to capture the grid maps and then stitch them to generate a larger map [Jiang et al. (2019)].

Metric Mapping. Geometric maps are based on the distance, and these map distances correlate and correspond to the distances found in the real world. They can be feature or landmark-based. While landmark needs feature identification or designing the environment, the dense technique is based entirely on the sensors to create the map. These sensors create a geometric representation of the environment surfaces [Burgard et al. (1996); Gutmann and Schlegel (1996), Zhang et al. (1995); Lu and Milios (1997)]. Other types of mapping are sensor level maps, which are sensor data derivations, and semantic maps, which are high-level decision enabling maps and contain object and space property details.

Hybrid Mapping. Hybrid mapping utilizes a mixed set of properties of any of the above mapping techniques, mainly metric and topological mapping [Buschka (2005)]. This technique takes in the best properties, depending on the task, the environment where it is implemented, and develops a map that could be used to accomplish the task.

New techniques in the area of mapping and localization have been developed over the last few decades. Many of these techniques incrementally and iteratively build maps and localize the robot, for every new sensor data scan that the robot accepts [Burgard et al. (1996); Zhang et al. (1995)]. The drawbacks of these techniques are their failure when large cyclical scan (open-loop) environments are involved, despite their high-speed processing. Cyclical environments will output cumulative errors that can grow exponentially and without any bounds. This is because, in these environments, backward temporal corrections tend to be time-consuming, and several systems may not be able to achieve acceptable results.

Mapping for autonomous mobile vehicles is a discipline related to computer vision [Fernandez-Madrigal (2012), Thrun et al. (2002)] and cartography [Leonard et al. (1992)]. In such environments, one of the preliminary tasks could be the development of a model of the world, using the map of the environment, making use of onboard sensors. The other task would be utilizing the constructed pre-existing map. The map can be developed using SLAM [Fernandez-Madrigal (2012), Dissanayake et al. (2001)]. This usage of the a priori information can be called the development of an autonomous vehicle for the known environment. An implementation of slam that utilizes multiple sensors.

Constructing a map can be exploratory [Mirowski et al. (2018)], without the use of any preexisting mapping information or an existing floor plan that details the presence of walls, floor, walls, ceiling, etc. Using the techniques of exploratory navigation [Mirowski et al. (2018)], the autonomous vehicle can develop the map and continue to navigate. If the floor plan is available, the system can create the map by traversing along with the building floor map and localize itself. In order to map the environment, a LiDAR can be used which provides a three-dimensional point cloud of the environment where the robot is situated. Hence, we can define a robotic mapping as that branch of robotics that deals with the study and application of the ability of the robot to construct the map or floor plan, of the environment where it is situated, using its sensors. An area of mapping that deals with the active mapping of the robot in its environment while simultaneously localizing itself is called Simultaneous Localization and Mapping (SLAM) [Pritsker (1986), Dissanayake et al. (2001); Davison et al. (2007); Sturm et al. (2012)]. There are various flavors of SLAM like EKF SLAM, FastSLAM (1 and 2), DP-SLAM, Parallel Tracking and Mapping (PTAM), ORBSLAM, MonoSLAM, and so on. However, a detailed study of SLAM is out of the scope of this survey. Aguilar developed a path planner based on RRT* [Aguilar et al. (2017)] for real-time navigation.

Localization. Localization is one of the most fundamental competencies required by an autonomous system, as the knowledge of the vehicle's location is an essential precursor to take any decisions about future actions, whether planned or unplanned. In a typical localization situation, a map of the environment or world is available and the robot is equipped with sensors that sense and observe the environment as well as monitor the robot's motion [Fernandez-Madrigal (2012), Huang and Dissanayake (1999), Huang and Dissanayake (2007), Liu et al. (2007)]. Hence, localization is that branch in autonomous system navigation, which deals with the study and application of the ability of a robot to localize itself in a map or plan.

The localization module informs the robot of its current position at any given time. A process of establishing the spatial relationship between the intelligent system and the stationary objects Localization is achieved using devices like Global Positioning Systems (GPS), odometric sensors, Inertial Measurement Units (IMU), etc. These sensors give the position information of the autonomous system, which can be used by the system to see where it is in the environment or the robot world [Leonard and Durrant-Whyte (1991), Betke and Gurvits (1997), Huang and Dissanayake (1999)]. Some important techniques of localization are listed below.

Dead Reckoning. Dead reckoning uses odometric data, trigonometric, and robotic kinematic algorithms to determine the distance traveled by the robot from its initial position. However, two major issues impact their performance. The robot has to know the initial position and the second is the time measurement related errors, which impact the accuracy and sometimes go below acceptable levels. Thrun et al. [Thrun et al. (2001)] used a probabilistic method to reduce the errors, known as particle filtering. Others used Extended Kalman Filter [Kwon et al. (2006)] and similar techniques to reduce the errors. Researchers utilized sensors like IMU to perform dead-reckoning [Ojeda and Borenstein (2007); Levi and Judd (1996)], while others used ultrasonic sensors with Kalman filters to improve the measurements [Burgard et al. (1996)].

Signal-Based Localization. Sensors that communicate via signals are several [Elnahrawy et al. (2004)], of which Radio Frequency Identification (RFID) [Neves et al. (2013) Whitehouse et al. (2007)], WiFi [He and Chan (2016)], and Bluetooth [Wang et al. (2015)] are a few. In this technique, the positions of a network of nodes are identified based on distance estimates between them.

Global Positioning. Outdoor navigation is involved in cases of outdoor search and rescue missions. Localization in such cases involves usage of Global Positioning Systems (GPS) that efficiently work only outdoors. GPS technology was first developed by NAVSTAR and is one of the favorite technologies to date for outdoor navigation. Some of the GPS companies are Navstar™, Garmin™, TomTom™, Mobius™, etc. to name a few. GPS provides very accurately (normal range up to one meter), some advanced GPS provide accuracy up to two centimeters like the Mobius agriculture mapping system, which is used on autonomous tractors.

Network of Sensors Localization. A sensor network is comprised of several sensors that can communicate either wirelessly or wired. Choi et al. combined RFID tags with an external camera to monitor the robot [Choi and Lee (2010)]. In some cases, ceiling-mounted cameras were used to improve localization when odometry data were fused with LiDAR [Ramer et al. (2015)]. The camera was used to locate obstacles and also to aid in the initial position estimation.

Vision-Based Localization. Sensors mounted on the robot provide the latest and accurate data concerning the robot. This system of sensors can be generalized to different environments and robots that use them and hence are sought after in the present research areas. The outdoor environment can be supported by a single or multiple sets of GPS and are fairly accurate. Indoor environments use LiDAR sensors [Fontanelli et al. (2007)] and/or vision-based sensors [Wan et al. (2016); Biswas and Veloso (2012)].

Indoor VR Localization. Indoor localization uses the new age technologies like Virtual Reality head-sets, and 3D laser sensors are on the rise. One such example is the HTC ViVe™ Lighthouse technology. This system floods a room with light invisible to the naked eye. Lighthouse functions as a reference point for any positional tracking device (like a VR headset or a game controller) to figure out where it is in real 3D space. The lighthouse system shoots light into the world to assist receiving systems localize themselves. The receivers, which are tiny photo sensors that detect the flashes and the laser light, are placed on various locations on the vehicle—in this case, the wheelchair. When a flash initiates, the receiver starts counting until it detects the photosensor situated on it gets hit by a laser beam and uses the relationship between where that photosensor exists on the wheelchair, and when the beam hits the photosensor, to mathematically calculate its exact position relative to the base stations in the room. When we have detection by enough of the photosensors with a laser at the same time, they form a pose that provides the position and the direction of the wheelchair. This is called an inside-out tracking system since the headset uses external signals to figure out where it is.

Path Planning. Path Planning is an important subtask of autonomous navigation and is generally termed as a problem of searching for a path which an autonomous system has to follow in a described environment and requires the vehicle to go in the direction closest to the goal, and generally, the map of the area is already known [Buniyamin et al. (2011); Popovic et al. (2017); Laghmara et al (2019); Rashid et al. (2013)]. Path planning when used in conjunction with techniques of obstacle avoidance [Rashid et al. (2013)] gives a more robust deployment of the path planner module by enabling the system to avoid hazardous collision objects, nogo zones, and negative objects like potholes and similar objects.

Path planners can be designed based on the following properties: (1) Complete or Heuristic: A complete type of path planner was designed by Wagner et al. [Wagner and Choset (2011)] in which a multi system path planner uses both coupled and decoupled algorithms and hence benefits from both of the techniques. Urdiales et al. designed a complete path planner [Urdiales et al. (1998)] by using a pyramid structure for pre-processing the information to existing classical path planners. Heuristic approaches were applied by Mac et al. (2016). Vokhmintsev et al. (2017) designed yet another heuristic path planned that could be used in unknown dynamic environments, (2) Global or Local: Global path planners use environment information available a priori to navigate. Information about the environment will be known a priori and can consist of maps, cells, grid, and so on. A complete path is generated from source to target, before the vehicle starts moving [Marin-Plaza et al. (2018)]. Some of the global planners are Voronoi [Bhattacharya and Gavrilova (2007)] by Bhattacharya et al., Silhouette [Canny (1987)] by Canny et al., Dijkstra [Skiena (1990)] by Skiena et al, A* by Dechter et al. [Dechter and Pearl (1985)], Neural Network based by Yang et al. [Yang and Luo (2004)], and so on. A local path planner was proposed by Buniyamin et al. [Buniyamin et al. (2011)] in which they use bug algorithm to detect obstacles in the environments using onboard sensors and plan the path. This is a local planner that uses obstacle border to guide the vehicle towards the target, until the required target achievement conditions are met. They propose a new algorithm ‘PointBug’ that minimizes the use of the border (outer periphery), in order to generate a path from source to target. Some of the local path planners are based on [Marin-Plaza et al. (2018)] Splines as given by Piazzi et al. (2002), Bezier lines as given by Rastelli et al. (2014), arcs and segments by Reeds et al. (1990), Clothoids lines [Gim et al. (2017)], and so on. (3) Static or Dynamic: When an autonomous system encounters static objects in its path, it can perform static path planning and, if it encounters moving objects, it performs dynamic path planning. Kumar et al. did initial research on static and dynamic path planners on humanoid robots [Kumar et al. (2019)]. They developed a novel controller that represents static path planner as a single robot encountering random static obstacles and dynamic planner as multiple robots encountering random static obstacles. They use a Petri-net controller. Tuba et al. (2019) developed an optimal path planner that encounters static obstacles. They used harmony search algorithm and adapted it to their requirements for static obstacles and danger or no-go zones. Dutta et al. (2019) developed a static path planner for snake-like robots when they encounter static obstacles using a critical snakeBug algorithm.

As recent as 2020, Gabardos et al. (2020) discussed the methods for a variant of dynamic path planning that were based on multisensor fusion to detect the pose, size, and shape of the object along the planned route. The dynamic routing is accomplished by interpolation of the route poses, with some being re-positioned. Connell et al. developed dynamic path planners [Connell and La (2017)] for mobile robots with replanning using RRT. Liu et al. (2019) developed a dynamic path planner using an improvised ant colony optimization algorithm. They simulate the algorithm on a grid map.

Obstacle Avoidance. For successful navigation of an autonomous system, avoiding obstacles while in motion is an absolute requirement [Danescu (2011); Wu and Nevatia (2005); Chavez-Garcia and Aycard (2016); Borenstein and Koren (1988); Ravid and Remeli (2019)]. The vehicles must be able to navigate in their environment safely. Obstacle avoidance involves choosing the best direction among multiple non-obstructed directions, in real-time, hence obstacle avoidance can be considered to be more challenging than path planning.

Obstacles can be of two types (i) Immobile Obstacles (ii) Mobile Obstacles. Static object detection deals with localizing objects that are immobile in an environment—for example, of indoor static obstacles, can be a table, sofa, bed, planter, TV stand, walls, etc. Outdoor static obstacles can be buildings, trees, parked vehicles, poles (light, communication), (standing or sitting) persons, animals lying down, etc. Moving object detection deals with localizing the dynamic objects through different data frames obtained by the sensors to estimate their future state example of indoor moving objects can be walking or running pets at home, moving persons, operating vacuum robots, crawling baby, people moving in wheelchairs, etc. Outdoor moving obstacles can, for instance, be moving vehicles, pedestrians walking on the pathway, moving ball thrown in the air, flying drone(s), running pets, etc. The object's state has to be updated at each time instance. Moving object localization is not a simple task even with precise localization information. The challenge increases when the environment is cluttered with obstacles. The obstacles can be detected using two approaches that rely on prior mapped knowledge of the targets or the environments [Wang et al. (2007); Vu (2009); Baltzakis et al. (2003); Borenstein and Koren (1988); Borenstein and Koren (1991)]. These are the (i) Feature-based approaches that use LiDAR and detect the dynamic features of the objects; and (ii) Appearance-based approaches that use cameras and detect moving objects or temporally static objects.

The task of obstacle avoidance keeps the vehicle from colliding with obstacles and keeping the vehicle in a safe zone. It is a process that starts with identifying objects that are present in the environment and obstacle avoidance is a critical component of autonomous system navigation [Danescu (2011)]. Autonomous vehicles must be able to navigate their environment safely. We can broadly classify obstacle avoidance into static and mobile obstacle avoidance [Saunders et al. (2005); Chu et al. (2012)]. As the name suggests, static obstacle avoidance deals with navigating around obstacles that do not move and only the autonomous vehicle are in motion. Static obstacle avoidance is a process of establishing the temporal and spatial relationship between the mobile vehicle and the immobile obstacles—for example, a sofa in a living room. In contrast, mobile obstacle avoidance is a process of establishing the temporal and spatial relationship between the mobile objects in the environment, in addition to the vehicle and stationary objects. While path planning requires the vehicle to go in the direction nearest to the goal [Rashid et al. (2013)], and generally the map of the area is known, obstacle avoidance entails selection of the best direction among several unobstructed directions in real time.

Any autonomous system, or autonomous navigation function based system, must be aware of the presence of obstacles. When such a system deals with human assistance, the obstacle problem becomes even more critical, since there is zero-tolerance for failure. Objects are detected, identified and deemed as obstacles by the system. The obstacles can either be static or mobile. If it is a static obstacle, the problem reduces to the detection of present position and avoidance. If the obstacle is mobile, an autonomous system should not only know where the obstacle currently is but also track where the obstacle could be in the near future. This reason prompts us to perceive the obstacles as dynamic entities and the task of obstacle avoidance is a complex one.

There are several existing approaches for solving the obstacle avoidance problem; some commonly used approaches are the traditional object detection through Vector Field Histogram (VFH) [Borenstein and Koren (1991); Dalal and Triggs (2005); Felzenszwalb et al. (2009)], the Dynamic-Window Approach [Fox et al. (1997)] and occupancy grid algorithm [Elfes (1989), Danescu (2011)], and the Potential field method [Cho et al. (2018)]. The classification and localization of every object of importance and interest are necessary for the obstacle detection and avoidance tasks for a robot that uses cameras. Some of the traditional methods use Histograms [Dalal and Triggs (2005)1 Felzenszwalb et al. (2009); Borenstein and Koren (1991)] and have provided good results. However, techniques using Neural Network (NN) or Deep Learning (DL) have continually been outperforming them like passive DL techniques given in [Redmon and Farhadi (2017); Redmon et al. (2016)] to name a few. There are real-time NN techniques like [Ren et al. (2015)] that can detect much quicker compared to the traditional techniques. Recent research has produced two fundamental paradigms for modeling indoor robot environments: the grid-based paradigm and the topological paradigm.

Grid-based approaches [Moravec (1988), Elfes (1989), Borenstein and Koren (1991)] represent the robot environments as evenly-spaced grids. Each grid cell may contain a representation of an obstacle or a free path to the target as applicable. Topological approaches [Engelson and McDermott (1992), Kortenkamp and Weymouth (1994), Kuipers and Byun (1991)] represent robot environments as graphs. The nodes represent situations, areas, or objects (landmarks) (such as doorways, windows, signboards). The nodes are interconnected by arcs if the two nodes have a direct path between them. Both these robot mappings have demonstrated orthogonal strengths and weaknesses. Occupancy grids are easy to construct and maintain in large-scale environments [Thrun and Bucken (1996), Thrun et al. (1996)] and establish different areas based on the robot's geometric position within a global coordinate frame. The position of the robot is incrementally estimated using the odometric information and sensor readings taken by itself. Thus, the number of sensors readings are unbounded and are utilized here to determine the robot's location.

Contrary to this, topological approaches determine the position of the robot relative to the model primarily based on the environment's landmarks or distinct, the temporal sensor features [Thrun and Bucken (1996)]. For example, if the robot traverses two places that seem identical, topological approaches often have difficulty determining if these places are the same or not especially if they have been approached through different paths. In addition, since sensory input usually depends strongly on the robot's viewpoint, if its sensory input is ambiguous, topological approaches may fail to recognize geometrically nearby places even in static environments, making it difficult to construct large-scale maps. Contrary to this, grid-based approaches are hampered by their enormous space and time complexity. This is because the resolution of a grid must be fine enough to capture the details of the robot world. This limitation is reduced in topological approached by their compactness. The resolution of topological maps corresponds directly to the complexity of the environment. The compactness of topological representations gives them three key advantages over grid-based approaches: (i) fast planning, (ii) interfacing to symbolic planners and problem-solvers, and (iii) natural interfaces for a human speech like instructions (such as “goto kitchen”). Topological maps recover early from slippage and drift since they do not require the exact determination of the geometric position of the robot which must be constantly be monitored and compensated as in a grid-based approach.

Fusion of Sensor Data for Autonomous Navigation. This section discusses how to use output of fusion in autonomous navigation and its related subtasks as highlighted in Section 5.4.

Mapping. Thrun et al. (2000-2002), presented a novel algorithm which is strictly incremental in its approach [Thrun et al. (2001), Thrun et al. (2002)]. The basic idea is to combine posterior estimation with incremental map construction using maximum likelihood estimators [Thrun and Bucken (1996), Thrun (2002)]. This resulted in an algorithm that can build large maps in cyclical environments in real-time, even on a low footprint computer like a micro-computer e.g., Odroid XU4. The posterior estimation approach enables robots to localize themselves globally in maps developed by other linked robots and thus making it possible to fuse data collected by more than one robot at a time. They extended their work to generate 3D maps, where multi-resolution algorithms are utilized to generate low complexity 3D models of indoor environments:

$${m}_{t} = \{ 〈 {𝒪}_{τ} , {\hat{s}}_{t} 〉 \} where τ = 0 , 1 , 2 , 3 … t \qquad ( 5.1 )$$

where: Oτ: laser scan, \hat{ }sτ: laser scan's pose, τ: time index

$${arg max}_{x} P ( m \vert {d}_{t} ) \qquad ( 5.11 )$$

where data dt are a sequence of LiDAR measurements and odometry readings dt={s0, a0, s1, a1, . . . st, at}, where sτ denotes an observation (laser range scan), aτ denotes an odometry reading, and t and τ are time indexes. It is assumed that observations and odometry readings alternate each other.

The assumption is that, when a robot receives a sensor scan, it is not likely that an obstacle is perceived in future measurements when it scans space previously perceived as free. The likelihood is inversely proportional to the distance between previous and current measurements:

$${\hat{s}}_{t} = {arg max}_{{s}_{t}} P ( {s}_{t} \vert {o}_{t} , {a}_{t - 1} , {\hat{s}}_{t - 1} ) \qquad ( 5.12 )$$

The results are determined using a gradient ascent algorithm. The result of the search, \hat{ }st, and its corresponding scan ot are appended to the map.

As recent as 2019, Akhtar et al. (2019) developed a data fusion system that was used to create a 3D Model with a depth map and object 3D reconstruction. Jin et al. (2019) proposed an approach for SLAM using 2D LiDAR and stereo camera with loop closures to estimate odometry. As recent as 2020, Andersen et al. have used LiDAR and camera fusion for fast and accurate mapping in autonomous racing [Andresen et al. (2020)]. They develop a planning pipeline in addition to perception and mapping and implement it on an autonomous race car, for the “Formula Student Germany (FSG) driverless competition” and placed first.

Localization. Localization of an autonomous vehicle typically uses sensors like GPS, odometric, IMU with magnetometer, accelerometer, and so on. The data fusion in these sensors is challenging due to the presence of drift, as in a GPS module. The data fusion should also consider the drift and counter it with applicable measurements in order to have the system localize itself accurately. After the data are successfully fused in the perception module, the information is passed on to the control module and the control module uses this information in an iterative manner. When the data fusion system detects an obstacle, it passes this information as well to the controller, and it invokes the obstacle avoidance segment as required.

As a second example, consider simultaneous localization and mapping (SLAM). In SLAM, the integrated output of the perception module is input to Zhang et al. (2008), who proposed a robust model that used the MM-estimate technique for segment based SLAM in dynamic environments. The raw 2D laser rangefinder data were split into laser segments and enhanced with outliers of the moving objects. However, they state that the SLAM performance would deteriorate if the moving objects start and stop often for short intervals, as they may be misrepresented as features. This is because the monocular camera lines are mostly static after the required processing. They mitigate this by integrating the laser segments with line features and removing the pseudo segments using Bayesian techniques.

They improved this technique using MPEF-SLAM [Zhang et al. (2012)] wherein they implemented the state estimates from each of the monocular cameras and the LiDAR SLAM. This increased the accuracy of localization as it reduced the covariance of the robot pose.

As part of detection research, Wei. et al. (2018) fused LiDAR data and camera data using fuzzy logic and progressed to successfully implement SLAM and eventually perform detection of obstacles. Information is passed on to the control module, and the control module iteratively uses this information. When the data fusion system detects an obstacle, it passes this information as well to the controller, and it invokes the obstacle avoidance segment as required.

Path Planning. As mentioned in the previous section(s), path planning is an important task in autonomous navigation in which a system can perform global planning using pre-existing maps or local planning when no maps exist a priori. This means that the path planning is dependent on mapping. In cases where the autonomous vehicle encounters static or moving obstacles, it uses obstacle avoidance techniques. Hence, the usage of sensors is vital.

Wang et al. (2019) developed a vision based sensor fusion platform for path planning on a mobile robot. They use a pseudo-range processing method for vision based sensor fusion using heterogeneous sensors. They also use precise GPS, inertial and orientation sensors.

Ali et al. (2019) developed an approach for a three-wheeled mobile robot in an online navigation of road following and roundabout environments. They developed a complete planner in which the sensor fusion was used to remove noise and uncertainties from the sensors. The motion controller was used to control the kinematics of the vehicle by using a resolved acceleration control integrated with an active force controller to reject high disturbances. Gwon et al. (2020) developed sweeper robots for the curling Olympic games by developing a sensor fusion system that inputs to a path planner based on path estimation of a curling stone. The task of the robot was to clear the path efficiently so that the curling stone reaches its intended location. The trajectory of the stone was calculated/recalculated in an optimal time step using the trend-adjusted exponential smoothing method. We see that path planning and obstacle avoidance was key and they relied on the on-board sensors to provide the optimum situation awareness to achieve the task.

Xi et al. (2019) proposed a mapping approach to improve the accuracy of the robot swarm navigation by using a grid-map that used multi-sensor data fusion. They also proposed a path planning algorithm based on an improved intelligent water droplet algorithm. Their data fusion framework comprises of radar and depth camera sensors. They system verified the map construction based on the fused sensor data.

Sabe et al. (2004) used occupancy grids to find the path from robot source or current location to its goal; using this, the robot can safely reach the target location. They achieve this by defining every occupancy grid cell as a node that connects to a neighboring cell and also define the path planning problem as a search problem, using an A* search algorithm.

Obstacle Avoidance. Cameras and LiDARs can be used to detect objects. A 3D point cloud is an output from the LiDAR and an RGB image or depth image (with pointcloud in some cases). In order to operate efficiently, the autonomous vehicle needs accurate data from each of its sensors. The reliability of the operation of an autonomous vehicle is hence proportional to the accuracy and hence the quality of the associated sensors. Each type of sensor has its own limitations. Given below are some of their specific limitations: LiDAR: Weather phenomena as in rain, snow, fog [Rasshofer et al. (2011)]; Stereo vision: Distance from target, Baseline [Kyto et al. (2011)]; Ultrasound: Pollutants [Duong Pham et al. (2009)].

Sensor data fusion is effective whenever multiple sensors (homogeneous or heterogeneous) are utilized and data fusion is not limited to the field of robotics [Choi and Lee (2010)] and in fact surveillance [Dan et al. (2012)], gesture recognition [Caputo et al. (2012)], smart canes [Mutiara et al. (2016)], guiding glasses [Pacha (2013)] use this concept efficiently. The effective temporal, spatial and geometrical alignment of this suite of heterogeneous sensors and the diversity utilization is called sensor data fusion [Luo et al. (2002); Lahat et al. (2015)]. Depth perception cameras provide limited depth information in addition to data-rich image data. Although cameras have the advantage of providing extremely rich data almost equivalent to the human eye, they need significantly complex machine vision techniques that require high computing power. In addition to his challenge, the operational limitation can be attributed to adequate lighting and visibility. Cameras are used very efficiently in detecting sign recognition, pedestrian detection [Leibe et al. (2005); Breitenstein et al. (2010);], lane departure [Stein (2016)], identification of objects [Sigel et al. (2003), Boreczky and Rowe (1996), Sheikh and Shah (2005)]. Cameras are much cheaper compared to radars or LiDARs [De Silva et al. (2018)]. Hence the community prefers them over other sensors in certain applications. Both LiDARs and Depth Cameras contain depth-sensing sensors. While the cameras estimate the depth information using disparity information in the image, the LiDAR generates depth information from the environment. Each sensor has its pros and cons. The depth cameras provide rich depth information, but their field of view is quite narrow. In contrast, the LiDARs contain an excellent field of view but do not provide rich environment information and instead provide sparse information [John et al. (2017), Choi and Lee (2010), Pacha (2013)]. The LiDAR provides information in the form of point cloud while the camera gives luminance. We can see that these sensors can complement each other and can be used in complex applications. This is the advantage that we focus on in this study. Caltagirone et al. successfully developed a neural network that detected the road [Caltagirone et al. (2019)]. They projected an unstructured and sparse point cloud on the camera plane and un-sample it to obtain a set of dense 2D images. Multiple CNNs were trained to detect the roads. They found out that the fused data from the two sensors were better in terms of data accuracy and detail as compared to the individual sensors.

Huber et al. studied LiDAR and camera integration [Huber et al. (2011)] and found that the sparse information in the LiDAR may not be useful for complex applications and that a data fusion with a sensor that has rich information is useful. They also establish that stereo vision camera performs poorly in areas without texture and scenes containing repetitive structures, and hence its subsequent fusion with LiDAR leads to a degraded estimation of the 3D structure. They proved that fusing the LiDAR data directly into the depth camera reduces false positives and increases the disparity image density in the texture-less surface and hence reducing the disparity space. They devised a method to use the LiDAR information and then deduce the most optimum disparity information per pixel in the image. The advantages this provides are reduced computation and better disparity image quality. An added advantage is path propagation since we can predict the expected or final disparity and the related gradient.

Banerjee et al. developed a data fusion system of online camera and LiDAR data. Instead of using an exhaustive grid search for extrinsic calibration, they used a gradient-free optimizer [Banerjee et al. (2018)]. This gives their technique a low footprint, a lightweight quality, and the ability to execute in real time on an onboard computer on the vehicle. Recently, Manghat et al. developed a real-time tracking system that used LiDAR and camera in early 2020 [Manghat and El-Sharkawy (2020)]. They focus on tracking in this research due to its importance in autonomous navigation assistance systems like active driver assistance systems (ADAS), forward collision warning system (FCW), adaptive cruise control, and collision by breaking (ACCCB). The optimal state of the objects is estimated by obtaining the states of each sensor and then fusing them to improve the state estimations of the objects in the environment. Asvadi et al. developed a multimodal vehicle detection system by fusing RGB camera and 3D LiDAR data [Asvadi et al. (2018)] in 2018. This was used in identifying obstacles surrounding the autonomous vehicle. Three modalities such as a dense map (DM) consisting of the LiDAR's sparse data which was an upsampled output, high resolution map from the LiDAR's reflectance data called Reflectance Map (RM), and RGB image from a monocular camera extrinsically calibrated to the LiDAR the three sources of data were input to the CovNet detectors and later integrated to improve the detection.

After a successful data fusion, the output of the fusion can be used to detect objects. There is a substantial list of detection algorithms and [Wu and Nevatia (2005), Redmon and Farhadi (2017), Danescu (2011)] they can very efficiently detect objects in the environment where the autonomous vehicle operates. As an example, consider an autonomous wheelchair that operates in a known environment, i.e., an environment has been mapped and the vehicle needs to navigate to known destinations. If the environment does not change, the operator of the vehicle may just use the stored navigation routes and reach the destination from the source—for example, the living room to the kitchen. However, in an environment like a house, obstacles like chairs may have been moved, a child could be playing in the living room, or an assistive dog may be lying on the floor and resting. These could be termed as obstacles that the vehicle needs to avoid, or it will end up harming the child, pet, or operator. Hence, the need for the vehicle to operate with accurate situation awareness (SA) information. For efficient SA, the wheelchair may need to deal with a two-tier sensor data fusion. The first tier could be the outer loop of the LiDAR that detects the distant objects, obstacles, etc. The second tier could be, for instance, a stereo vision camera Realsense D435 output, which could be used for immediate object detection, recognition, and avoidance as needed. There are many classical methods for the detection of objects in an image, such as dense image pyramids and classifier pyramids [Dollar et al. (2014)]. Various feature detection methods such as fast feature pyramids that can quickly calculate places in the image where there could potentially be a person [Dollar et al. (2014)]. The Speed is around 30 Frames per second. In addition, we reviewed R-CNN and their variants, including the original R-CNN, Fast R-CNN [Girshick (2015)], and Faster R-CNN [Ren et al. (2015)], Single Shot Detector (SSDs) [Liu et al. (2016)], and a Fast version of You Only Look Once (YOLO-Fast) [Redmon et al. (2016), Redmon et al. (2016), Redmon and Farhadi (2017)].

The raw signal is sensed and processed. Using classification techniques using technologies like YOLO, a preliminary classification can be performed. The KITTI provides benchmark [Geiger et al. (2012)] results. Qi et al. (2018) performed an object classification for 3D object detection using RGB-D data and Complex-YOLO technique, a flavor of fast YOLO by Simon et al. (2018). This first level of classification is performed on the data and features are extracted. It is fed through an alignment process, in order to correlate the LiDAR data points with the stereo vision camera pixel data. Finally, a second classification is performed using the features, in order to extract the details of the objects.

Dynamic obstacle avoidance techniques like the dynamic window approach to collision avoidance by Fox et al. (1997) or the real-time obstacle dependent Gaussian obstacle avoidance system Potential Field [Cho et al. (2018)] use the principles of real-time situation awareness and dynamic obstacle avoidance to provide safe operation in a hazardous environment. Dynamic obstacle avoidance demands a true real-time behavior-based system to sense the environment of the autonomous vehicle.

As part of this survey, we have briefly introduced sensor data fusion and autonomous navigation. We have reviewed the most popular data fusion techniques that can be used in navigation tasks for intelligent mobility systems. This survey is by no means exhaustive, due to the nature of the research area. However, it provides adequate information to the audience by reviewing the laser and optical sensors like LiDAR and camera, respectively. A brief look into the task of autonomous navigation, while explaining its sub-tasks namely mapping, localization, and obstacle avoidance is accomplished. The multi-disciplinary nature of data fusion was researched, and it was found that multiple sensors are better than one when used for autonomous vehicle tasks like robot navigation. The acute need for a robust data fusion process, methodology, and logic are described, and a discussion of the concepts of robot perception is provided, in addition to presenting some of the previous works that have performed seminal research in this area.

We have observed from research publications how data fusion can drive the future of autonomous systems and extend algorithms into areas of commercial autonomous systems, in addition to military systems. Estimation and filtering techniques such as Kalman filters, particle filters, and similar techniques are briefly discussed and also the need for their usage is provided.

A comparison of the different types of data fusion and their pros and cons are provided as well. Some inexpensive but robust sensors like the Intel Realsense D435 and RPLiDAR were researched, and their performance and capabilities are documented and references to top performers (although expensive sensors) sensors like Velodyne and eclipse are given. As a first look into sensor fusion, calibration techniques suggested by some leading manufacturers are provided. In conclusion, we state again that using a good perception system with an appropriate data fusion system is vital for the optimal functioning of an autonomous system and its task of navigation.

### V. Examples

The following examples as well as the figures are included to demonstrate preferred embodiments of the invention. It should be appreciated by those of skill in the art that the techniques disclosed in the examples or figures represent techniques discovered by the inventors to function well in the practice of the invention and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1 Smart Wheelchair Motor Controller System

The Wheelchair Motor Controller System is a fully integrated hardware-software platform designed to enable precise, intelligent, and safe operation of a powered wheelchair. It combines a real-time embedded control unit (based on an STM32 microcontroller), an advanced motion control driver (Sabertooth 2×32), multimodal sensing (joystick, IMU, encoder), and an interactive desktop dashboard for live monitoring, logging, and visualization (illustrated in FIG. 7). This system is ideal for prototyping, research, or real-world deployment in assistive mobility applications where safety, responsiveness, and real-time feedback are paramount. This is also a fully integrated embedded control and monitoring solution designed to enhance the safety, responsiveness, and usability of powered wheelchairs. Built around an STM32-based controller and a Python-powered GUI, this system incorporates real-time feedback loops, joystick-driven motion, inertial measurement, and user-friendly software interfaces to visualize and record dynamic behavior. It seamlessly bridges hardware (STM32+sensors) and software (Python GUI+3D visualization), providing a robust framework for experimentation, real-world deployment, and future expansion.

### A. Microcontroller: STM32 NUCLEO-L412 KB

At the heart of the system is the STM32 NUCLEO-L412 KB microcontroller board. This ARM Cortex-M4-based MCU provides: (i) Pulse width modulation (PWM) generation to control motor speed precisely through the Sabertooth driver. (ii) Analogue to digital converter (ADC) channels for real-time analog input from dual-axis joystick (Tank mode). (iii) Timer Encoder Interface for reading quadrature encoder pulses from wheel-mounted encoders. (iv) Inter-integrated circuit (I2C) communication to interface with the MPU6050 6-axis IMU for orientation sensing. (v) Universal synchronous/asynchronous receiver-transmitter (USART) communication to stream diagnostic and control data to an external GUI dashboard.

### B. Coding (STM32CubeIDE Project)

Coding in STM32CubeIDE involves using the STM32CubeIDE development environment to program STM32 microcontrollers, which serve as the control brain for certain features. STM32CubeIDE is an integrated development environment (IDE) provided by STMicroelectronics, combining code editing, debugging, and configuration tools tailored for their STM32 microcontroller units (MCUs). In certain aspects coding is provided for: PWM Motor Control to drives left/right wheels using Sabertooth 2×32 driver. ADC Joystick Input (Tank Mode) to read two-axis analog joystick for intuitive movement. Quadrature Encoder Feedback to track wheel rotation via TIM encoder mode. MPU6050 IMU Integration to capture real-time pitch, roll, and yaw via I2C. IMU-Based PID Stabilization to actively balance or correct tilt using feedback. UART Logging to stream orientation and joystick data to a PC in real time.

The STM32 firmware, developed in STM32CubeIDE using HAL libraries, contains modular code for initialization, motor control logic, stabilization routines, and sensor fusion. Motion control using Sabertooth 2×32 Motor Driver. The Sabertooth 2×32 motor driver receives PWM input signals from the STM32 and provides high-efficiency, bidirectional current to the wheelchair's left and right motors. Key features include a Dual-channel 32A continuous output for robust performance. Seamless compatibility with RC-style PWM or analog voltage input. Built-in current sensing, thermal protection, and regenerative braking. This enables reliable actuation even under high load or terrain variation, making it ideal for motorized wheelchair applications.

### C. Sensing and Feedback Integration

Joystick (ADC via STM32) reads left and right vertical axes independently. Tank drive logic: Each joystick channel maps directly to one motor. MPU6050 IMU (I2C) 3-axis gyroscope+3-axis accelerometer. Provides raw data and filtered pitch, roll, yaw. Used in a Mahony AHRS filter for real-time orientation estimation. Quadrature Encoders (TIM in Encoder Mode) provides high-resolution feedback on wheel rotation. Used for speed estimation, distance tracking, and closed-loop stabilization.

### D. Real-Time GUI Dashboard

The system includes a robust Python-based desktop dashboard, featuring: Real-time plots: Live graphs for joystick input and IMU orientation. 3D visualization: VPython-based 3D rendering of the wheelchair's orientation. Auto COM port detection: Automatically connects to the correct serial port. CSV logging: All data (orientation, joystick, encoder) saved to timestamped logs. Multi-window layout: Separate GUI panes for plotting and control. OTA updater: Checks and installs updates with integrity verification. Standalone executable+installer: Built using PyInstaller and NSIS, supports optional auto-start on boot and desktop shortcuts.

### E. Python GUI Dashboard

Real-Time Data Visualization plots orientation (roll, pitch, yaw) vs time. Plots joystick ADC values vs time having a multi-window GUI using tkinter+matplotlib and 3D Orientation Viewer using VPython. Box visualization responds to live IMU angles. Auto COM Port Detection provides no need to manually specify the port. CSV Logging logs all sensor values, joystick states, and timestamps. Automatic Startup (Windows Registry) optionally adds the app to run at boot. Standalone Executable generated using PyInstaller (-onefile, -windowed), NSIS-Based Installer: Professional installation wizard with: Optional desktop shortcut, Enable/disable auto-start, Launch on completion. OTA Updater Script automatically checks for and downloads new versions, ensures version integrity (e.g., SHA256), I2C initialization (e.g., I2C1 on NUCLEO-L412 KB), MPU6050 register configuration, reading acceleration and gyroscope data, data structures for real-time pitch, roll, and yaw estimation.

Target Pin Assignments (NUCLEO-L412KB)

| Function | Pin | Peripheral |
|---|---|---|
| Left Encoder A | PA6 | TIM3_CH1 |
| Left Encoder B | PA7 | TIM3_CH2 |
| Right Encoder A | PB6 | TIM4_CH1 |
| Right Encoder B | PB7 | TIM4_CH2 |
| I2C SDA | PB9 | I2C1 |
| I2C SCL | PB8 | I2C1 |
| UART TX | PA2 | USART2 |
| UART RX | PA3 | USART2 |

Encoder Feedback Support include TIM configured in Encoder Interface Mode reads quadrature encoder pulses for each motor and allows speed and distance tracking.

IMU-Based Stabilization Controller Computes pitch and roll from MPU6050 Uses a complementary filter for orientation estimation. Adds a PID controller to correct deviations in posture or slope.

### F. Category Benefit

Accessibility simplifies control and monitoring for users with physical limitations. Real-time Safety IMU-based stabilization prevents unsafe tilting or overcorrection. Diagnostics logs complete motion history for review or debugging. Modularity easy to add new sensors, control modes, or AI-based enhancements. User experience GUI includes real-time plots, 3D orientation, and intuitive controls. Deployment ready one-click installer and standalone executable support deployment. Maintainability OTA updater ensures system stays current with minimal user effort. A sketch of one example of a simple controller is provided in FIG. 8.

Benefits of this framework include less expensive than Nvidia, reconfigurable and modular. Uses opensource coding using C, C++ and python programming. Energy footprint is much smaller than the previous version.

1. A brain computer interface (BCI) configured to translate event related potentials (ERP) in electroencephalograph (EEG) wave forms into commands executable by an assistance device(s) or system(s) comprising a user interface coupled to an electroencephalograph (EEG) decoder that is configured to receive and analyze EPR in EEG wave forms and producing a command signal.

2. The interface of claim 1, wherein the EPR is a visually evoked ERP in combination with a cognitive ERP.

3. The interface of claim 1, wherein the ERP comprises a steady state visually evoked potential (SSVEP) using Riemannian manifold classifiers.

4. An electroencephalograph (EEG) decoder comprising (i) an input module coupled to (ii) a fast Fourier transform (FFT) module which is operably coupled to (iii) a wave band analysis module that generates a command to be sent to one or more device or system.

5. The decoder of claim 4, wherein the wave band analysis uses Riemannian geometry based signal classification system to generate commands that are sent to one or more devices or systems.

6. A mobility system comprising:
a brain computer interface (BCI) configured to receive electroencephalograph (EEG) waveforms, analyze event related potentials (ERP) EEG wave forms in a plurality of predetermined frequency ranges or band types forming a signal, and generate a command based on the signal generated by ERP analysis;
one or more environmental sensors configured to receive active and passive information regarding an environment;
a mobility platform configured to receive input from the brain computer interface and the one or more environmental sensors to regulate the function of the mobility platform.
